(19) United States
(12) Patent Application Publication
(10) Pub. No.: US 2023/0141235 A1
(43) Pub. Date: May 11, 2023

(54) EVACUATION TRAVEL ASSISTANCE DEVICE, EVACUATION TRAVEL ASSISTANCE METHOD, AND NON-TRANSITORY COMPUTER READABLE RECORDING MEDIUM

(71) Applicant: Mitsubishi Electric Corporation, Tokyo (JP)

(72) Inventors: Shogo OKAMOTO, Tokyo (JP); Masaya ENDO, Tokyo (JP)

(73) Assignee: Mitsubishi Electric Corporation, Tokyo (JP)

(21) Appl. No.: 17/897,936

(22) Filed: Aug. 29, 2022

(30) Foreign Application Priority Data
Nov. 5, 2021 (JP) 2021-180712

(51) Int. Cl. B60W 30/14; B60W 10/20; B60W 60/00; B60W 40/08; B60W 40/02; G01S 13/08

(52) U.S. Cl. CPC B60W 30/143; B60W 10/20; B60W 60/0016; B60W 40/08; B60W 40/02; G01S 13/08; B60W 2420/52; B60W 2552/50; B60W 2552/53; B60W 2554/80; B60W 2556/20; B60W 2556/40

(57) ABSTRACT

A surrounding environment information generating unit acquires surrounding position information indicating a measured position of a side wall including a side wall of an evacuation spot, and generates measured map information for the side wall using the surrounding position information. When driving operation by a driver cannot be performed, a corrected map information generating unit calculates a correction value obtained by multiplying a difference between a distance from a traveling center line of a host vehicle to the side wall in base map information and that in the measured map information by a reliability, and generates corrected map information obtained by applying the correction value to the base map information. A route generating unit generates an evacuation travel route with the evacuation spot as a destination using the corrected map information. A vehicle control unit outputs a vehicle speed command for the host vehicle using the evacuation travel route.

### TECHNICAL FIELD

The present disclosure relates to an evacuation travel assistance device that causes a vehicle such as an automobile to automatically travel to an evacuation spot such as a road shoulder or an emergency parking zone by route following control or the like and stop at the evacuation spot, in an emergency such as when the vehicle automatically travels by lane following control or the like, and a driver becomes incapable of driving.

### BACKGROUND ART

Patent Literature 1 and Patent Literature 2 respectively disclose an evacuation travel assistance device and a vehicle control system that evacuate a host vehicle to an evacuation spot that does not obstruct traveling of other vehicles when lowering of driver's consciousness is detected.

The evacuation travel assistance device disclosed in Patent Literature 1 determines, for each of a plurality of spots that can be traveling destinations of the host vehicle, a risk of stopping at the spot and a risk of passing through the spot on the basis of map information, host vehicle information, and surrounding environment information, and sets an evacuation route from a current location of the host vehicle to an evacuation destination by combining the evacuation destination which is a spot where the risk of stopping is lower than a predetermined standard and spots where the risk of passing is lower than a predetermined standard.

The vehicle control system disclosed in Patent Literature 2 determines a stop position on the basis of a detection result from an external environment recognition device that detects an object or the like outside the vehicle, acquires a state of a road shoulder, and changes at least one of a speed of entering the road shoulder, and a distance between a position of entering the road shoulder and the stop position depending on the state of the road shoulder.

### CITATION LIST

### Patent Literatures

Patent Literature 1: JP 2015-228089 A

Patent Literature 2: JP 2020-163984 A

### SUMMARY OF INVENTION

### Technical Problem

The evacuation travel assistance device disclosed in Patent Literature 1 determines an evacuation destination or the like in consideration of map information on an area around the host vehicle.

Therefore, when the map information is deviated from the actual stop position, the accuracy of a risk map itself indicating a risk level may deteriorate.

The vehicle control system disclosed in Patent Literature 2 extracts and determines a stop position by referring to map information on the basis of a host vehicle position, determines a route for reaching the stop position, and causes the vehicle to travel to the stop position along the determined route.

Therefore, when the map information is deviated from the actual stop position, there is a possibility that the determination accuracy of the stop position is lowered.

The present disclosure has been made in view of the above points, and an object of the present disclosure is to obtain an evacuation travel assistance device capable of causing a vehicle to automatically travel and stop at an evacuation spot with high accuracy even if a deviation occurs between map information and the actual evacuation spot.

### Solution to Problem

An evacuation travel assistance device according to the present disclosure includes: processing circuitry to acquire driver state information and determine whether a driver is capable of driving on a basis of the driver state information, the driver state information making it possible to estimate whether the driver is in a state where the driver can perform a driving operation; to acquire host vehicle environment information including host vehicle position information indicating a position of a host vehicle; to acquire map information on a road that is a traveling destination of the host vehicle and obtain, on a basis of the map information, base map information; to acquire surrounding environment information including surrounding position information and division line information and generate measured map information for a side wall including a side wall of an evacuation spot on a basis of the surrounding position information, the surrounding position information indicating a position of the side wall including the side wall of the evacuation spot measured by a surrounding environment information acquiring device, the division line information indicating a division line of a traveling path measured by the surrounding environment information acquiring device; to calculate a correction value obtained by multiplying a difference between a distance from a traveling center line of the host vehicle to the side wall including the side wall of the evacuation spot in the base map information and a distance from the traveling center line of the host vehicle to the side wall including the side wall of the evacuation spot in the measured map information by a reliability that is equal to or less than 1 when it is determined that the driving operation by the driver cannot be performed, and generate corrected map information obtained by applying the correction value to the base map information; to generate, when it is determined that the driving operation by the driver cannot be performed, an evacuation travel route with the evacuation spot as a destination spot by using the host vehicle position information and the corrected map information; and to output, when it is determined that the driving operation by the driver cannot be performed, a vehicle speed command on a basis of the evacuation travel route, the vehicle speed command being a command for performing speed control and steering control of the host vehicle that performs evacuation travel.

### Advantageous Effects of Invention

According to the present disclosure, when the driving operation by the driver cannot be performed, the corrected map information obtained by correcting the position information of the evacuation spot indicated by the map information using the position information of the evacuation spot indicated by the surrounding environment information from the surrounding environment information acquiring device is used to generate the evacuation travel route with the evacuation spot as the destination spot, and the evacuation travel is performed. Therefore, the position information of the evacuation spot for the evacuation travel route is more accurate, and it is possible to cause the vehicle to automatically travel and stop at the evacuation spot with high accuracy.

### BRIEF DESCRIPTION OF DRAWINGS

FIG. 1 is a block diagram illustrating a configuration example of a vehicle control system including an evacuation travel assistance device according to a first embodiment.

FIG. 2 is a diagram illustrating a transmission wave with which a millimeter-wave radar irradiates a side wall including an emergency parking zone.

FIG. 3 is a diagram illustrating an example of a reflected wave from the side wall including the emergency parking zone.

FIG. 4 is a diagram illustrating another example of a reflected wave from the side wall including the emergency parking zone.

FIG. 5 is a diagram schematically illustrating an example of base map information that the evacuation travel assistance device according to the first embodiment can obtain.

FIG. 6 is a diagram schematically illustrating an example of an evacuation spot in the base map information that the evacuation travel assistance device according to the first embodiment can obtain.

FIG. 7 is a diagram schematically illustrating a first example of measured map information that the evacuation travel assistance device according to the first embodiment can obtain.

FIG. 8 is a diagram schematically illustrating a second example of the measured map information that the evacuation travel assistance device according to the first embodiment can obtain.

FIG. 9 is a diagram illustrating reliability based on reception intensity and reception density of an incoming wave in the evacuation travel assistance device according to the first embodiment.

FIG. 10 is a diagram illustrating a first example of a relationship among a distance indicated by the base map information, a distance indicated by the measured map information, a reliability, and a distance indicated by corrected map information at a point P4 in the evacuation travel assistance device according to the first embodiment.

FIG. 11 is a diagram schematically illustrating the relationship of the first example illustrated in FIG. 10.

FIG. 12 is a diagram illustrating a second example of the relationship among the distance indicated by the base map information, the distance indicated by the measured map information, the reliability, and the distance indicated by the corrected map information at the point P4 in the evacuation travel assistance device according to the first embodiment.

FIG. 13 is a diagram schematically illustrating the relationship of the second example illustrated in FIG. 12.

FIG. 14 is a diagram illustrating a hardware configuration example of the evacuation travel assistance device according to the first embodiment.

FIG. 15 is a flowchart illustrating an operation example of the evacuation travel assistance device according to the first embodiment.

FIG. 16 is a diagram illustrating an example of a relationship among the distance indicated by the base map information, the distance indicated by the measured map information, the reliability, and the distance indicated by the corrected map information at a point P1 to a point P8 in the evacuation travel assistance device according to the first embodiment.

FIG. 17 is a diagram schematically illustrating a relationship between a position indicated by the base map information and a position indicated by the corrected map information when the position indicated by the base map information is located to the right of the position indicated by the measured map information in the evacuation travel assistance device according to the first embodiment.

FIG. 18 is a diagram schematically illustrating a relationship between a position indicated by the base map information and a position indicated by the corrected map information when the position indicated by the base map information is located to the left of the position indicated by the measured map information in the evacuation travel assistance device according to the first embodiment.

FIG. 19 is a diagram schematically illustrating a relationship between a position indicated by the base map information and a position indicated by the corrected map information when the position indicated by the base map information is located to the left of a position of the actual side wall in the evacuation travel assistance device according to the first embodiment.

FIG. 20 is a diagram schematically illustrating a relationship between a position indicated by the base map information and a position indicated by the corrected map information when the position indicated by the base map information is the same as the position indicated by the measured map information in the evacuation travel assistance device according to the first embodiment.

FIG. 21 is a block diagram illustrating a configuration example of a vehicle control system including an evacuation travel assistance device according to a second embodiment.

FIG. 22 is a diagram illustrating a situation in which an irradiation direction of a radio wave from a millimeter-wave radar to the side wall including the emergency parking zone is switched when a driver state determining unit determines that a driving operation by a driver can be performed in the evacuation travel assistance device according to the second embodiment.

FIG. 23 is a diagram illustrating a situation in which the irradiation direction of the radio wave from the millimeter-wave radar to the side wall including the emergency parking zone is switched when the driver state determining unit determines that the driving operation by the driver cannot be performed in the evacuation travel assistance device according to the second embodiment.

FIG. 24 is a flowchart illustrating an operation example of the evacuation travel assistance device according to the second embodiment.

FIG. 25 is a block diagram illustrating a configuration example of a vehicle control system including an evacuation travel assistance device according to a third embodiment.

FIG. 26 is a diagram illustrating a first example of second reliability used by a corrected map information generating unit in the evacuation travel assistance device according to the third embodiment.

FIG. 27 is a diagram illustrating a second example of the second reliability used by the corrected map information generating unit in the evacuation travel assistance device according to the third embodiment.

FIG. 28 is a flowchart illustrating an operation example of the evacuation travel assistance device according to the third embodiment.

FIG. 29 is a diagram illustrating a first example of a relationship among a distance indicated by base map information, a distance indicated by measured map information, a reliability, and a distance indicated by corrected map information at a point P1 to a point P8 in the evacuation travel assistance device according to the third embodiment.

FIG. 30 is a diagram illustrating a second example of the relationship among the distance indicated by the base map information, the distance indicated by the measured map information, the reliability, and the distance indicated by the corrected map information at the point P1 to the point P8 in the evacuation travel assistance device according to the third embodiment.

### DESCRIPTION OF EMBODIMENTS

### First Embodiment

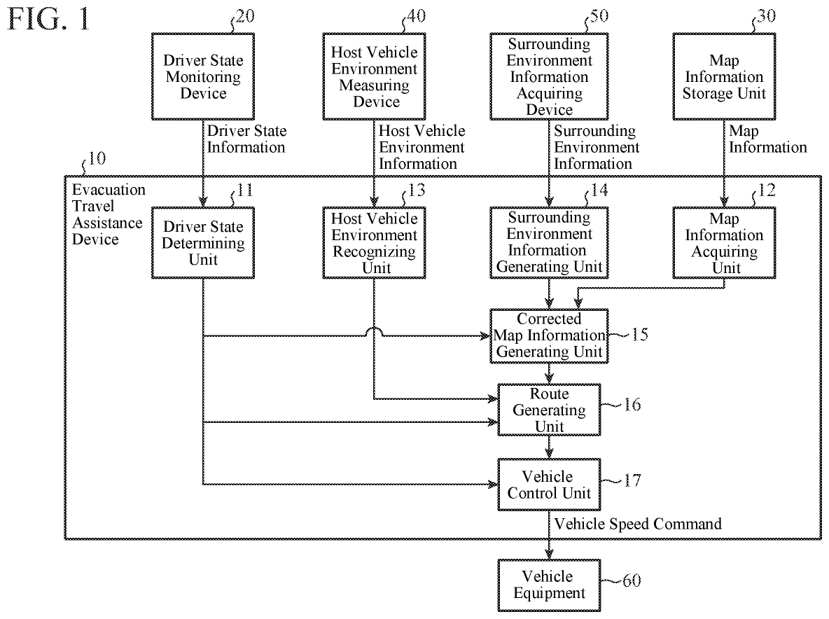

An evacuation travel assistance device 10 according to a first embodiment will be described with reference to FIGS. 1 to 19.

Note that the drawings are schematically illustrated, and omission of components or simplification of components is made according to the needs for convenience of description.

In addition, the mutual relationship between sizes and positions of components and the likes illustrated in different drawings is not necessarily described accurately, and is changed according to the needs for easy understanding of description.

In the drawings, the same reference numerals indicate the same or corresponding parts, and some parts are omitted in the description of components in order to avoid duplication.

As illustrated in FIG. 1, a vehicle control system including the evacuation travel assistance device 10 according to the first embodiment includes a driver state monitoring device 20, a map information storage unit 30, a host vehicle environment measuring device 40, and a surrounding environment information acquiring device 50 in addition to the evacuation travel assistance device 10.

Note that a vehicle controlled by the evacuation travel assistance device 10 will be described as a host vehicle except for special cases.

Before describing the evacuation travel assistance device 10 according to the first embodiment, the driver state monitoring device 20, the map information storage unit 30, the host vehicle environment measuring device 40, and the surrounding environment information acquiring device 50 will be described.

The driver state monitoring device 20 includes at least one sensor such as an imaging device, a steering angle sensor, a grip sensor, a wearable device, an infrared sensor, or a seating sensor, monitors the state of a driver, and outputs driver state information to the evacuation travel assistance device 10 via communication means such as radio.

The driver state information is information which makes it possible to estimate whether the driver is in a state where the driver can perform the driving operation.

The imaging device images a driver sitting on a seat of the vehicle, and outputs driver movement information that is one piece of the driver state information and indicates movement of the face, an eye line, or the like of the driver. The imaging device is, for example, a digital camera using a solid-state imaging element such as a CCD or a CMOS.

The steering angle sensor monitors an operation state of the driver and outputs operation state information which is one piece of the driver state information.

The grip sensor is provided on the steering wheel, detects whether or not the steering wheel is gripped, and outputs grip information of the driver, which is one piece of the driver state information. The grip sensor is, for example, a capacitive sensor or a piezoelectric element.

The wearable device and the infrared sensor detect vital information including a heart rate, a body temperature, a blood pressure, and the like of the driver, and output the vital information of the driver, which is one piece of the driver state information.

The map information storage unit 30 stores map information on a road which is a traveling destination of the host vehicle.

The map information indicates a travel environment in which the host vehicle is traveling, and includes road linear information, lane information, junction information, and road boundary information.

The road linear information is information indicating curvature, gradient, and the like.

The lane information is information indicating the number of lanes, a lane type, a length of a lane, and a width of a lane.

The lane type includes a cruising lane, a passing lane, a merging path, a branch path, a road shoulder, and the like.

The junction information is information indicating a branch point, a merging point, and the like.

The road boundary information is information indicating a guard rail, a side wall, a fence, and the like.

The map information storage unit 30 is a storage device included in the vehicle control system, and in this case, map information is acquired in advance and stored in the storage device.

The map information stored in the map information storage unit 30 is map information obtained from a locator, which is a commonly used device for measuring the host vehicle position.

In addition, the map information storage unit 30 may be a storage device outside the host vehicle, and in this case, the evacuation travel assistance device 10 acquires map information via a satellite every time the map information is used.

In the map information obtained from the locator, in general, map information up to a fairly distant position invisible from the vehicle can be acquired in advance, but the position indicated by the map information is often deviated from the actual position.

The host vehicle environment measuring device 40 includes a device that measures a position such as a positioning sensor and a device that measures a physical quantity representing a movement state of the vehicle such as a vehicle speed sensor, an acceleration sensor, or a yaw rate sensor. The host vehicle environment measuring device 40 detects the movement state and the like of the host vehicle, and outputs host vehicle environment information including host vehicle position information to the evacuation travel assistance device 10 via communication means.

The positioning sensor measures a position of the vehicle, and outputs the host vehicle position information which is one piece of the host vehicle environment information.

The vehicle speed sensor detects a speed of the vehicle and outputs speed information which is one piece of the host vehicle environment information.

The acceleration sensor detects an acceleration of the vehicle and outputs acceleration information which is one piece of the host vehicle environment information.

The yaw rate sensor detects an angular velocity around a vertical axis of the vehicle and outputs angular velocity information which is one piece of the host vehicle environment information. The yaw rate sensor is, for example, a gyro sensor.

The surrounding environment information acquiring device 50 includes a millimeter-wave radar, a camera, a light detection and ranging (LiDAR), or the like. The surrounding environment information acquiring device 50 detects and measures a speed and a position of a different vehicle in an area (hereinafter, referred to as a set area) in which a surrounding area of the host vehicle in the front-rear and left-right directions is set, a distance from the host vehicle to the different vehicle, a position of an obstacle in the set area including a stationary object such as a side wall, a distance from the host vehicle to the obstacle, a division line of the traveling path, and the like. The surrounding environment information acquiring device 50 outputs surrounding environment information to the evacuation travel assistance device 10 via communication means.

The millimeter-wave radar emits a transmission wave formed of a millimeter-wave radio wave to the surroundings of the vehicle as the set area, and detects positions of the different vehicle and the obstacle and the division line of the traveling path by capturing the reflected wave. The millimeter-wave radar outputs the detected information as the surrounding environment information including position information.

The millimeter-wave radar includes a front radar, a rear radar, and a pair of side radars that emit transmission waves to areas in front of, behind, and in left and right directions of the host vehicle, respectively.

The camera images the surroundings of the vehicle as the set area, and outputs the surrounding environment information on the basis of the imaged different vehicle and obstacle and the imaged division line of the traveling path.

The camera is, for example, a digital camera using a solid-state imaging element such as a CCD or a CMOS.

The camera includes a front camera, a rear camera, and a pair of side cameras that capture images of the areas in front of, behind, and in left and right directions of the host vehicle, respectively.

The LiDAR irradiates the surroundings of the vehicle, which is the set area, with light such as infrared rays and captures the reflected light to detect the positions of the different vehicle and the obstacle and the division line of the traveling path, and outputs the surrounding environment information.

The LiDAR includes a front LiDAR, a rear LiDAR, and a pair of side LiDARs that emit light to the areas in front of, behind, and in left and right directions of the host vehicle, respectively.

An example will be described below where a millimeter-wave radar that mainly detects a position of a side wall including a side wall of an emergency parking zone, which is an evacuation spot, is used as the surrounding environment information acquiring device 50 that obtains the surrounding environment information of an evacuation spot for the evacuation travel assistance device 10 according to the first embodiment.

In order to eliminate the complexity of the description, the surrounding environment information acquiring device 50 will be described as a millimeter-wave radar 50.

However, the surrounding environment information acquiring device 50 is not limited to the millimeter-wave radar, and may be a camera or a LiDAR.

Although the surrounding environment information obtained by the millimeter-wave radar 50 is information up to the distance visible from the vehicle, the position indicated by the position information included in the surrounding environment information obtained by the millimeter-wave radar 50 has higher accuracy than the position obtained by the map information obtained from the locator and stored in the map information storage unit 30, and indicates the actual position more accurately.

However, the position indicated by the position information measured by the millimeter-wave radar 50 does not always completely indicate the actual position, and some variation occurs due to the reception intensity and the reception density of the incoming wave by the reflected wave received by the millimeter-wave radar 50.

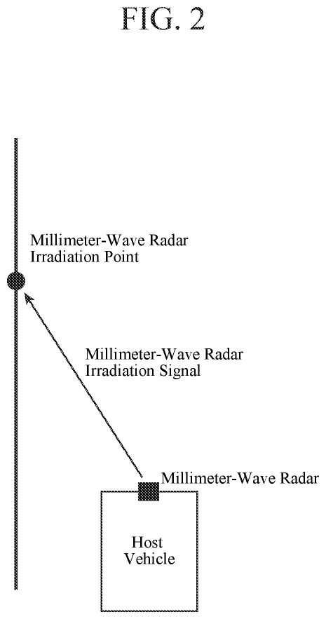

Now, as illustrated in FIG. 2, it is assumed that a transmission wave is emitted from the front millimeter-wave radar 50 mounted on the host vehicle toward an irradiation point on a side wall.

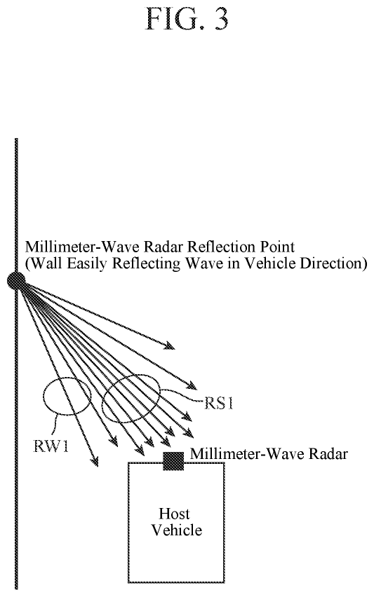

Assuming that the wall surface of the side wall is a wall that easily reflects the transmission wave in the direction of the host vehicle, the reception intensity and the reception density of the incoming wave by the reflected wave received by the millimeter-wave radar 50 are large because most of the reflected wave can be received as indicated by RS1 in FIG. 3.

As a result, the position indicated by the position information measured on the basis of the incoming wave received by the millimeter-wave radar 50 indicates the same value as or a value close to the position of the actual side wall.

In FIG. 3, RW1 represents a scattered reflected wave.

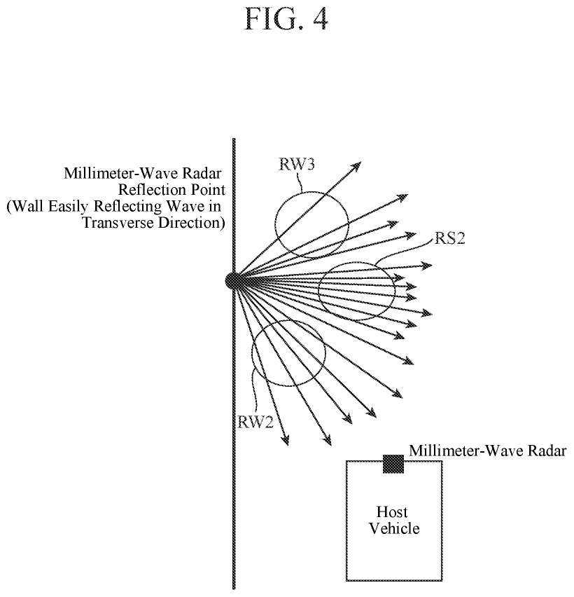

On the other hand, assuming that the wall surface of the side wall is a wall that easily reflects the transmission wave in the transverse direction, that is, in the direction perpendicular to the wall surface, the reception intensity and the reception density of the incoming wave by the reflected wave received by the millimeter-wave radar 50 are slightly smaller due to scattering of the reflected wave as indicated by RW2 in FIG. 4.

As a result, the detection accuracy of the position indicated by the position information measured on the basis of the incoming wave received by the millimeter-wave radar 50 is slightly deteriorated with respect to the position obtained when the wall that easily reflects the transmission wave in the direction of the host vehicle is measured.

In FIG. 4, RS2 indicates a reflected wave having a high reception density but not received by the millimeter-wave radar 50 as an incoming wave, and RW3 indicates a scattered reflected wave.

That is, due to the state of the wall surface of the side wall irradiated by the millimeter-wave radar 50, namely, the state in which the wall surface is uneven or slippery, the measured map information obtained by the millimeter-wave radar has some difference in detection accuracy, and it is not always possible to completely detect the position of the actual side wall The measured map information has some deviation.

However, the position indicated by the position information measured by the millimeter-wave radar 50 does not indicate a position deeper than the position of the actual side wall, that is, does not indicate a value larger than that of the position of the actual side wall.

Next, the evacuation travel assistance device 10 according to the first embodiment will be described.

In the evacuation travel assistance device 10 according to the first embodiment, in order to eliminate complication of the description, in the following description, the description will be provided by using mainly map information related to an emergency parking zone which is an evacuation spot and the vicinity thereof and map information related to a side wall including a side wall of the emergency parking zone as map information.

Note that in the following description, the emergency parking zone will be described as the evacuation spot, but the evacuation travel assistance device 10 operates similarly to the case of the emergency parking zone even in the case of a road shoulder being as the evacuation spot.

The evacuation travel assistance device 10 is mounted on a vehicle capable of autonomous driving as a part of the vehicle control system. The evacuation travel assistance device 10 causes the vehicle to automatically travel to an evacuation spot such as a road shoulder or an emergency parking zone by route following control or the like and stop at the evacuation spot, in an emergency such as when the host vehicle automatically travels on an automobile exclusive road on which the emergency parking zone is present by lane following control or the like in accordance with a vehicle speed command from a vehicle control unit 17, and a driving operation by a driver cannot be performed.

Therefore, a description will be given on the assumption of a state in which the host vehicle is automatically traveling on an automobile exclusive road by lane following control in accordance with a vehicle speed command indicating automatic traveling driving from the vehicle control unit 17.

The vehicle speed command is a control signal indicating speed control and steering control of the vehicle.

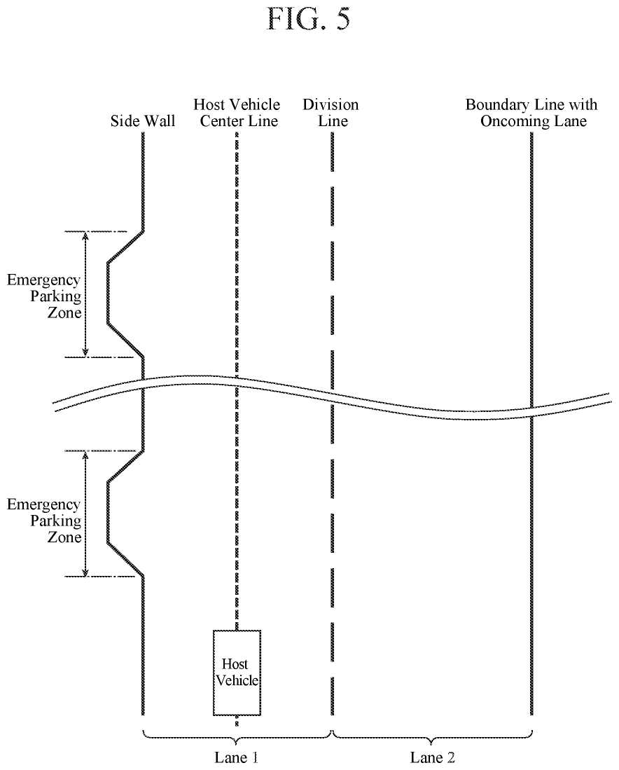

As illustrated in FIG. 5, the automobile exclusive road is, for example, a road which has two lanes including a lane 1 and a lane 2 and where an emergency parking zone is present on the left side of an area in front of the host vehicle.

The lane on which the host vehicle is traveling is any of the left lane which is the lane 1 and the right lane which is the lane 2.

The map information illustrated in FIG. 5 indicates a travel environment in which the host vehicle is traveling, and schematically illustrates an example of the map information from the locator stored in the map information storage unit 30.

FIG. 5 illustrates a state in which the host vehicle is traveling on the left lane.

In FIG. 5, a line passing through the center of the host vehicle is illustrated as a host vehicle center line which is a virtual line.

The evacuation travel assistance device 10 starts in an emergency such as when a driving operation by the driver cannot be performed in a state where the vehicle automatically travels by the lane following control in accordance with the vehicle speed command from the vehicle control unit 17, and ends in a state where the host vehicle stops in the evacuation spot by the route following control.

The autonomous driving which carries out the evacuation travel from the start to the end is hereinafter referred to as evacuation travel assistance.

Note that, the automatic traveling control such as the lane following control and the route following control of the vehicle in accordance with the vehicle speed command indicating the automatic traveling driving from the vehicle control unit 17 is automatic traveling control well known in this type of field, and thus a detailed description thereof will be omitted.

In the evacuation travel assistance, the evacuation travel assistance device 10 calculates measured map information including distance information to a side wall including a side wall of an emergency parking zone, which is an evacuation spot, by using surrounding environment information on the side wall including the side wall of the emergency parking zone measured by the millimeter-wave radar 50. The evacuation travel assistance device 10 calculates a correction value, by using distance information of the measured map information and distance information of base map information including distance information to the side wall obtained on the basis of map information including the emergency parking zone and map information on the side wall including the side wall of the emergency parking zone acquired from the map information storage unit 30. The evacuation travel assistance device 10 obtains a vehicle speed command for performing evacuation travel by using corrected map information obtained by correcting the base map information with the correction value, and then outputs the vehicle speed command to vehicle equipment 60.

That is, in the evacuation travel assistance, the evacuation travel assistance device 10 obtains corrected map information obtained by correcting the base map information with a correction value obtained on the basis of the distance from the traveling center line of the host vehicle to the side wall including the side wall of the emergency parking zone based on the distance information of the base map information and the distance from the traveling center line of the host vehicle to the side wall including the side wall of the emergency parking zone based on the distance information of the measured map information. Then the evacuation travel assistance device 10 generates an evacuation travel route with the emergency parking zone as a destination spot by using the corrected map information, and outputs a vehicle speed command for performing evacuation travel by autonomous driving on the basis of the generated evacuation travel route.

The evacuation travel assistance device 10 includes a driver state determining unit 11, a map information acquiring unit 12, a host vehicle environment recognizing unit 13, a surrounding environment information generating unit 14, a corrected map information generating unit 15, a route generating unit 16, and the vehicle control unit 17.

The driver state determining unit 11 acquires the driver state information from the driver state monitoring device 20, and determines whether or not the driver can drive on the basis of the acquired driver state information.

The determination on whether or not driving is possible by the driver state determining unit 11 is performed, for example, as follows.

The information for determination may be one or a combination of two or more pieces of information.

1) On the basis of the driver movement information obtained by imaging the driver, it is determined that the driving operation by the driver cannot be performed when the driver is shutting his or her eyes for a certain period of time or more due to dozing or when the driver has kept his face downward for a certain period of time or more (a dead man state).

2) On the basis of the vital information of the driver, it is determined that the driving operation by the driver cannot be performed when there is an abnormality in the vital function such as the heartbeat of the driver.

3) On the basis of the grip information of the driver, it is determined that the driving operation by the driver cannot be performed when the driver does not hold the steering wheel for a certain period of time (a dead man state).

When the driver state determining unit 11 determines that the driving operation by the driver cannot be performed due to 1) to 3) described above or the like, the evacuation travel assistance device 10 starts an evacuation travel assistance operation.

That is, upon receiving the determination that the driving operation by the driver cannot be performed from the driver state determining unit 11, the vehicle control unit 17 switches from the vehicle speed command indicating the automatic traveling driving to the vehicle speed command for performing the route following control based on the speed control and the steering control of the host vehicle that performs the evacuation travel, and outputs the vehicle speed command for performing the route following control of the evacuation travel.

The map information acquiring unit 12 acquires map information on a road that is a traveling destination of the host vehicle from the map information storage unit 30 as map information.

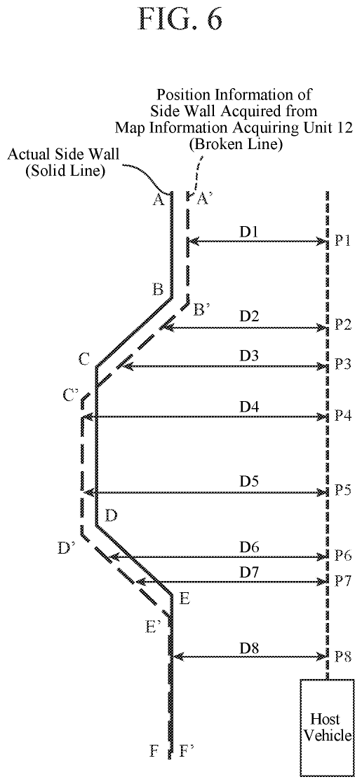

FIG. 6 illustrates base map information as an example for a side wall in the vicinity of an emergency parking zone including the emergency parking zone based on the acquired map information.

The base map information is map information including distance information indicating the distance from the traveling center line of the host vehicle to the side wall obtained on the basis of the map information stored in the map information storage unit 30.

FIG. 6 illustrates a section (hereinafter, referred to as a set section) of the set area from a point A to a point F in the vicinity of the emergency parking zone including the emergency parking zone, and a broken line indicates the position information of the side wall obtained from the base map information.

The points B to E correspond to the emergency parking zone, and the points A to B and the points E to F correspond to the vicinity of the emergency parking zone.

The points A to B and the points E to F correspond to the vicinity of the emergency parking zone for obtaining information necessary for the vehicle to park in the emergency parking zone. For example, the distance from the point A to the point B and the distance from the point E to the point F are each 5 m.

In FIG. 6, a solid line illustrated from the point A to the point F indicates a side wall including an actual side wall of the emergency parking zone illustrated for comparison with the position information of the side wall obtained from the base map information, and indicates a state in which the position of the side wall based on the map information obtained from the map information storage unit 30 is partially deviated from the position of the side wall including the actual side wall of the emergency parking zone.

In FIG. 6, the point A indicates a side wall of a cruising lane in front of the emergency parking zone, and the point F indicates a side wall of the cruising lane behind the emergency parking zone.

A section from the point B to the point E is a section of the emergency parking zone, the point B is a front end of the side wall of the emergency parking zone, the point E is a rear end of the side wall of the emergency parking zone, and a section from the point C to the point D is a side wall of a parking area.

In FIG. 6, the distance information of the base map information is information indicating distances from the center line of the host vehicle to the positions on the side wall from the point A′ (position corresponding to the point A of the set section) to the point F′ (position corresponding to the point F of the set section) illustrated in FIG. 6, which are lengths of lines when the lines are vertically drawn from the center line of the host vehicle toward the broken line indicated by the point A′ to the point F′, that is, distances D1 to D8 indicated by the double-headed arrows in the respective points P1 to P8 in FIG. 6.

Note that, in FIG. 6, information on eight points from the point P1 to the point P8 is used as the distance information, but the distance information is not limited to the eight points, and the number of points at which the distance information is obtained may be increased by narrowing the interval.

The host vehicle environment recognizing unit 13 acquires host vehicle environment information from the host vehicle environment measuring device 40.

In the evacuation travel assistance, host vehicle position information indicating the position of the host vehicle in the acquired host vehicle environment information is used.

The surrounding environment information generating unit 14 acquires surrounding environment information from the millimeter-wave radar 50, and generates measured map information for the side wall including the emergency parking zone on the basis of the acquired surrounding environment information.

In this example, the surrounding environment information from the millimeter-wave radar 50 includes position information of a side wall including a side wall of the emergency parking zone, a traveling center line of a lane on which the host vehicle is traveling, and reception intensity and reception density of an incoming wave from the millimeter-wave radar 50.

The position information of the side wall including the emergency parking zone is position information obtained on the basis of an incoming wave from the millimeter-wave radar 50 when the millimeter-wave radar 50 irradiates a side wall including a side wall of the emergency parking zone with a transmission wave that is a radio wave as illustrated in FIG. 2, and the millimeter-wave radar 50 receives a reflected wave reflected from the side wall as the incoming wave as illustrated in FIGS. 3 and 4.

The measured map information is map information indicating a side wall with respect to the traveling center line of the host vehicle on the basis of the distance information obtained by calculating the distance from the traveling center line of the lane to the position of the side wall indicated by the position information of the side wall from the millimeter-wave radar 50.

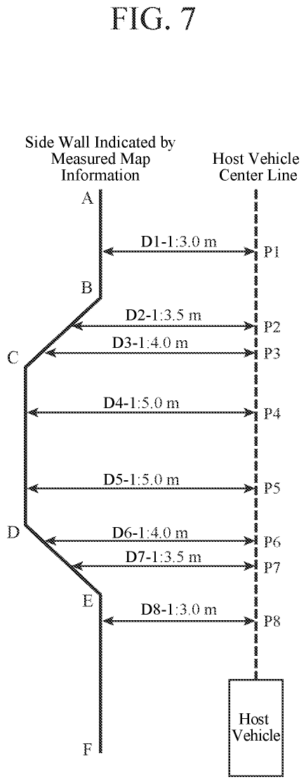

FIG. 7 illustrates first measured map information as an example obtained by the surrounding environment information generating unit 14 on the basis of the surrounding environment information from the millimeter-wave radar 50.

It is assumed that the position of the side wall indicated by the first measured map information is located to the right of the position of the side wall of the emergency parking zone indicated by the base map information.

FIG. 7 illustrates a section of the set area from the point A to the point F in the vicinity of the emergency parking zone including the emergency parking zone, and the section of the set area and the positions for which distance information is calculated are the same as those of the position information of the side wall obtained from the base map information.

The first measured map information includes distance information indicating that a distance D1-1 of the point P1 in the section from the point A to the point B is 3.0 m, a distance D2-1 of the point P2 in the section from the point B to the point C is 3.5 m, a distance D3-1 of the point P3 in the section from the point B to the point C is 4.0 m, a distance D4-1 of the point P4 in the section from the point C to the point D is 5.0 m, a distance D5-1 of the point P5 in the section from the point C to the point D is 5.0 m, a distance D6-1 of the point P6 in the section from the point D to the point E is 4.0 m, a distance D7-1 of the point P7 in the section from the point D to the point E is 3.5 m, and a distance D8-1 of the point P8 in the section from the point E to the point F is 3.0 m.

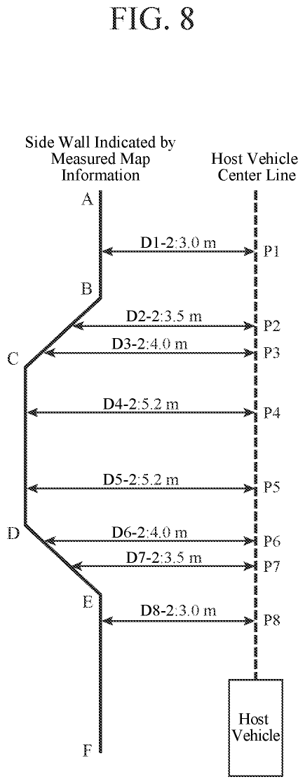

In addition, FIG. 8 illustrates second measured map information as another example obtained by the surrounding environment information generating unit 14 on the basis of the surrounding environment information from the millimeter-wave radar 50.

In contrast to the position of the side wall of the emergency parking zone indicated by the first measured map information, in the second measured map information, it is assumed that the position of the side wall of the emergency parking zone indicated by the second measured map information is located to the left of the position of the side wall of the emergency parking zone indicated by the base map information.

That is, in the second measured map information, a distance D4-2 at the point P4 is 5.2 m and a distance D5-2 at the point P5 is 5.2 m in the area of the side wall of the emergency parking zone, which are different from the distance D4-1 of 5.0 m at the point P4, and the distance D5-1 of 5.0 m at the point P5 in the first measured map information.

Further, in the second measured map information, a distance D1-2 at the point P1 is 3.0 m, a distance D2-2 at the point P2 is 3.5 m, a distance D3-2 at the point P3 is 4.0 m, a distance D6-2 at the point P6 is 4.0 m, a distance D7-2 at the point P7 is 3.5 m, and a distance D8-2 at the point P8 is 3.0 m, which are the same as distances at the points P1, P2, P3, P6, P7, and P8 in the first measured map information, respectively.

Note that, in the second measured map information, the section of the set area and the positions for which distance information is calculated are the same as those of the position information of the side wall obtained from the base map information.

When the driver state determining unit 11 determines that the driving operation by the driver cannot be performed, the corrected map information generating unit 15 compares the position information of the side wall including the side wall of the emergency parking zone in the base map information obtained by the map information acquiring unit 12 with the position information of the side wall including the side wall of the emergency parking zone in the measured map information generated by the surrounding environment information generating unit 14. The corrected map information generating unit 15 corrects the deviation between the position information of the side wall including the side wall of the emergency parking zone in the base map information and the position information of the side wall including the actual side wall of the emergency parking zone with the position information of the side wall including the side wall of the emergency parking zone in the measured map information.

When the driver state determining unit 11 determines that the driving operation by the driver cannot be performed, the corrected map information generating unit 15 calculates a correction value obtained by multiplying the difference between the distance from the traveling center line of the host vehicle to the side wall including the side wall of the emergency parking zone in the base map information obtained by the map information acquiring unit 12 and the distance from the traveling center line of the host vehicle to the side wall including the side wall of the emergency parking zone in the measured map information generated by the surrounding environment information generating unit 14 by a reliability that is equal to or less than 1. The corrected map information generating unit 15 generates corrected map information obtained by applying the correction value to the base map information obtained by the map information acquiring unit 12.

The reliability used by the corrected map information generating unit 15 is a measure indicating the reliability of the accuracy of the position information measured by the millimeter-wave radar 50, and is a value selected from values of a plurality of steps on the basis of the magnitude of the reception intensity and the reception density of the incoming wave received by the millimeter-wave radar 50.

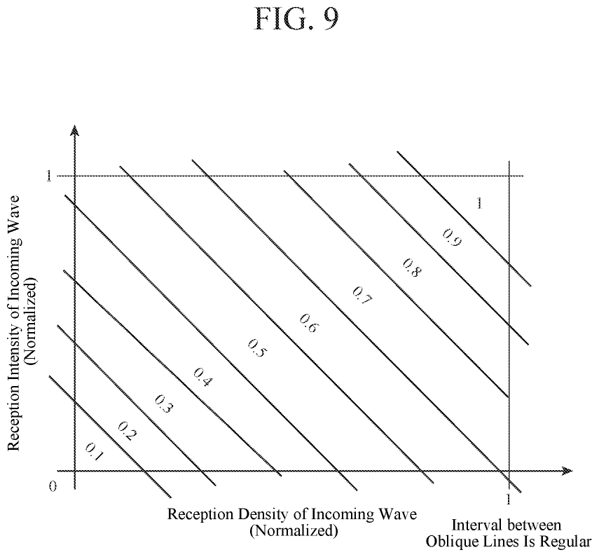

In FIG. 9, the horizontal axis represents the reception density of the incoming wave and the vertical axis represents the reception intensity of the incoming wave, the reception intensity and the reception density of the incoming wave are normalized, the normalized reception intensity and the normalized reception density of the incoming wave are plotted in FIG. 9, and thereby the reliabilities divided into 10 steps at 0.1 intervals from 0.1 to 1.0 based on the degrees of the reception intensity and the reception density of the incoming wave, that is, the magnitudes thereof are obtained.

Therefore, the corrected map information generating unit 15 selects one of the reliabilities illustrated in FIG. 9 in accordance with the reception intensity and the reception density of the incoming wave from the millimeter-wave radar 50 acquired by the surrounding environment information generating unit 14.

As the magnitude of the reception intensity and the reception density of the incoming wave increases, for example, as illustrated in FIG. 3, when most of the reflected wave can be received as the incoming wave and thereby the reception intensity and the reception density of the incoming wave are large, the reliability becomes a value closer to 1.0.

In addition, as the magnitude of the reception intensity and the reception density of the incoming wave decreases, for example, as illustrated in FIG. 4, when the reception intensity and the reception density of the incoming wave are small due to scattering of the reflected wave, the reliability becomes a value closer to 0.

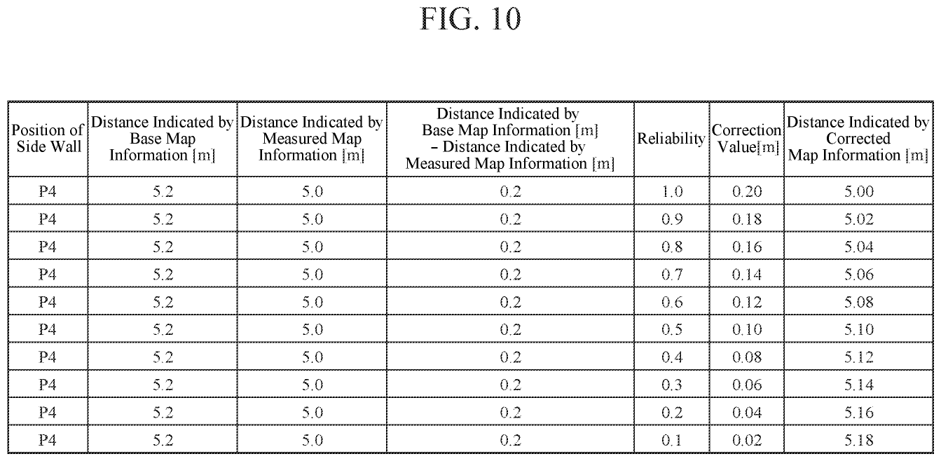

With respect to the corrected map information obtained by the corrected map information generating unit 15, an example of the relationship among the distance indicated by the base map information, the distance indicated by the measured map information, the reliability, and the distance indicated by the corrected map information will be described using the distance at the point P4 as an example with reference to FIGS. 10 to 13.

Although the point P4 will be described as an example, the same relationship as that of the point P4 is shown also at other points.

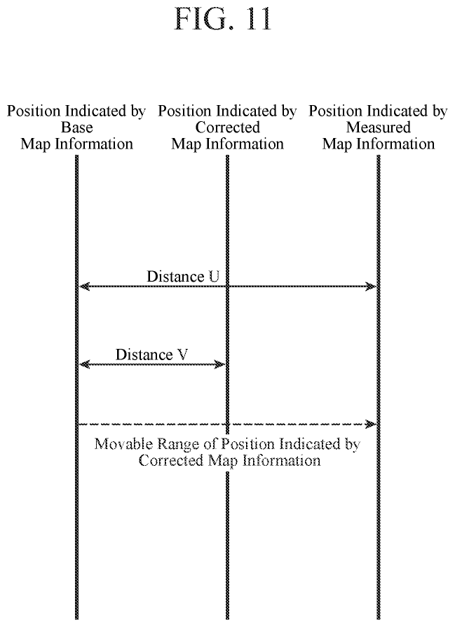

FIGS. 10 and 11 are diagrams assuming a case where the position of the side wall of the emergency parking zone indicated by the base map information is located on the left side with respect to the position of the side wall indicated by the measured map information illustrated in FIG. 7.

FIG. 10 illustrates the distance indicated by the corrected map information in a case where the reliability is changed from 0.1 to 1.0 in 10 steps at 0.1 intervals assuming that the distance indicated by the base map information is 5.2 m and the distance indicated by the measured map information is 5.0 m at the point P4, that is, the distance indicated by the base map information is deviated leftward by 0.2 m with respect to the distance indicated by the measured map information.

At this time, a difference between the distance indicated by the base map information and the distance indicated by the measured map information, that is, a value obtained by subtracting the distance indicated by the measured map information from the distance indicated by the base map information is 0.2 m.

As a result, values obtained by multiplying this difference by the reliabilities are from 0.02 m to 0.20 m, which are correction values of 10 steps sequentially increased by 0.02 m.

The distances indicated by the corrected map information are from 5.18 m to 5.00 m, which are obtained by subtracting the correction values from the distances indicated by the base map information as a reference and which are values of 10 steps sequentially decreased by 0.02 m.

That is, as illustrated in FIG. 11, the position indicated by the corrected map information has a value approaching the distance indicated by the measured map information indicating the actual position more accurately from the distance indicated by the base map information depending on the reliability.

When the reliability is 1.0, the distance indicated by the corrected map information is the distance indicated by the measured map information.

In FIG. 11, the distance U indicates a distance between the position of the side wall indicated by the base map information and the position of the side wall indicated by the measured map information, and corresponds to a difference between a distance from the traveling center line of the host vehicle to the side wall including the side wall of the emergency parking zone in the base map information and a distance from the traveling center line of the host vehicle to the side wall including the side wall of the emergency parking zone in the measured map information.

The distance V indicates a distance between the position of the side wall indicated by the base map information and the position of the side wall indicated by the corrected map information, and corresponds to the correction value calculated by the corrected map information generating unit 15.

The position of the side wall indicated by the corrected map information has a movable range of values that can be taken from the position of the side wall indicated by the base map information to the position of the side wall indicated by the measured map information.

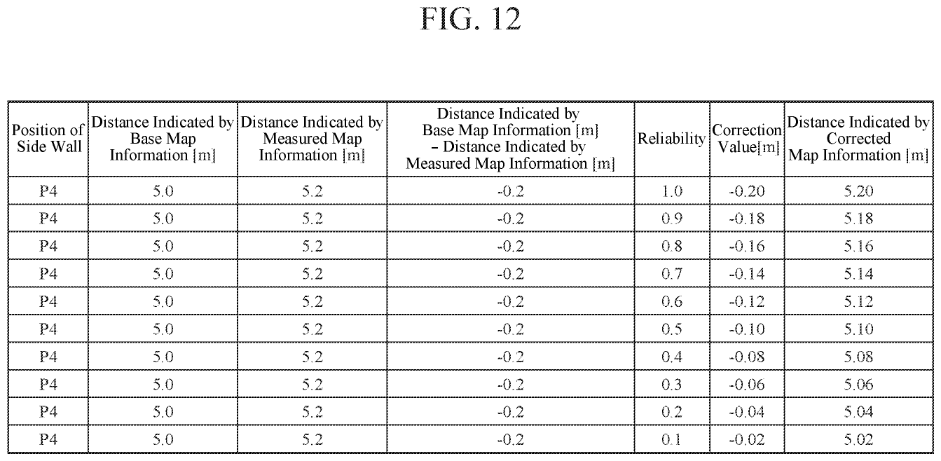

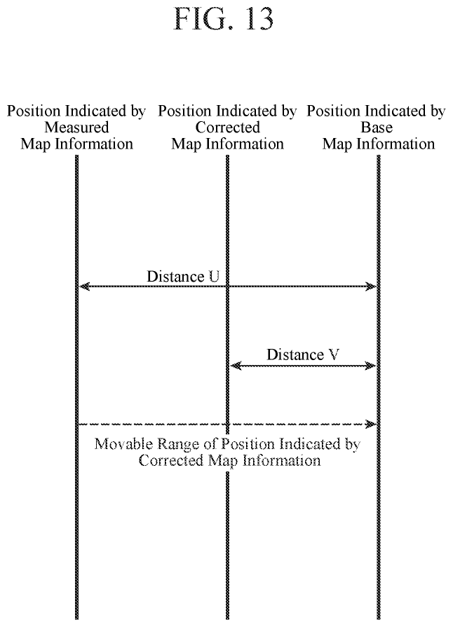

FIGS. 12 and 13 are diagrams assuming a case where the position of the side wall of the emergency parking zone indicated by the base map information is located on the right side with respect to the position of the side wall indicated by the measured map information illustrated in FIG. 8.

FIG. 12 illustrates the distance indicated by the corrected map information in a case where the reliability is changed from 0.1 to 1.0 in 10 steps at 0.1 intervals assuming that the distance indicated by the base map information is 5.0 and the distance indicated by the measured map information is 5.2 m at the point P4, that is, the distance indicated by the base map information is deviated rightward by 0.2 m with respect to the distance indicated by the measured map information.

At this time, a difference between the distance indicated by the base map information and the distance indicated by the measured map information, that is, a value obtained by subtracting the distance indicated by the measured map information from the distance indicated by the base map information is −0.2 m.

As a result, values obtained by multiplying this difference by the reliabilities are from −0.02 m to −0.20 m, which are correction values of 10 steps sequentially increased by −0.02 m.

The distances indicated by the corrected map information are from 5.02 m to 5.20 m, which are obtained by subtracting the correction values from the distances indicated by the base map information as a reference and which are values of 10 steps sequentially decreased by −0.02 m.

That is, as illustrated in FIG. 13, the position indicated by the corrected map information has a value approaching the distance indicated by the measured map information indicating the actual position more accurately from the distance indicated by the base map information depending on the reliability.

When the reliability is 1.0, the distance indicated by the corrected map information is the distance indicated by the measured map information.

In FIG. 13, the distance U indicates the distance between the position of the side wall indicated by the base map information and the position of the side wall indicated by the measured map information, and corresponds to a difference between the distance from the traveling center line of the host vehicle to the side wall including the side wall of the emergency parking zone in the base map information and the distance from the traveling center line of the host vehicle to the side wall including the side wall of the emergency parking zone in the measured map information.

The distance V indicates a distance between the position of the side wall indicated by the base map information and the position of the side wall indicated by the corrected map information, and corresponds to the correction value calculated by the corrected map information generating unit 15.

The position of the side wall indicated by the corrected map information has a movable range of values that can be taken from the position of the side wall indicated by the base map information to the position of the side wall indicated by the measured map information.

When the driver state determining unit 11 determines that the driving operation by the driver cannot be performed, the route generating unit 16 generates an evacuation travel route with the position of the host vehicle as a departure spot and the stop position in the emergency parking zone as a destination spot, using the host vehicle position information acquired by the host vehicle environment recognizing unit 13 and the corrected map information generated by the corrected map information generating unit 15.

The generation of the evacuation travel route by the route generating unit 16 uses a generation method of a travel route from the departure spot to the destination spot known in this type of field, for example, calculating a multi-dimensional polynomial connecting the departure spot and the destination spot.

When the driver state determining unit 11 determines that the driving operation by the driver cannot be performed, the vehicle control unit 17 calculates a target vehicle speed and a target steering angle on the basis of the evacuation travel route generated by the route generating unit 16, and outputs a vehicle speed command for performing speed control and steering control of the host vehicle to perform evacuation travel automatically following the evacuation travel route from the position of the host vehicle to the stop position in the emergency parking zone to the vehicle equipment 60.

The vehicle control unit 17 outputs the vehicle speed command for appropriately controlling the deceleration of the vehicle speed, the steering angle, and the like depending on the speed of the host vehicle, the presence or absence of a surrounding object, and the like to the vehicle equipment 60 so as to perform control to safely stop at the stop position in the emergency parking zone.

The vehicle equipment 60 is, for example, an adaptive cruise control (ACC) controller, an electric power steering (EPS) controller, or the like.

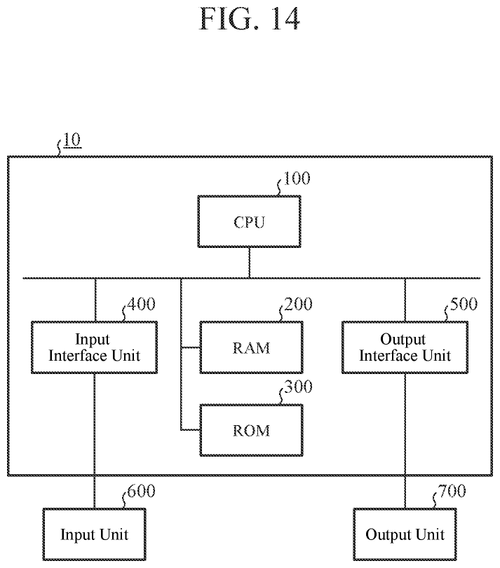

As illustrated in FIG. 14, the evacuation travel assistance device 10 including the driver state determining unit 11, the map information acquiring unit 12, the host vehicle environment recognizing unit 13, the surrounding environment information generating unit 14, the corrected map information generating unit 15, the route generating unit 16, and the vehicle control unit 17 includes a central processing unit (central processing unit, that is, CPU) 100, a large-capacity semiconductor memory (RAM: Random Access Memory) 200, a storage device (ROM: Read only memory) 300, an input interface unit 400, and an output interface unit 500. The evacuation travel assistance device 10 is driven by a general-purpose operating system (OS).

Various information is input from the driver state monitoring device 20, the map information storage unit 30, the host vehicle environment measuring device 40, and the surrounding environment information acquiring device 50, which correspond to an input unit 600, via the input interface unit 400, the program stored in the ROM 300 is loaded into the RAM 200, the CPU 100 executes various processes on the basis of the program loaded into the RAM 200, and a vehicle speed command, which is a result of the execution, is output to the vehicle equipment 60, which is an output unit 700, via the output interface unit 500.

The CPU 100 may be a microprocessor, a microcomputer, or a digital signal processor (a digital signal processor, that is, a DSP).

The storage device 300 is a type of storage medium, and may be a hard disk device (Hard disk drive, that is, HDD), a volatile or nonvolatile semiconductor memory such as, a flash memory, an erasable programmable read only memory (EPROM), or an electrically erasable programmable read-only memory (EEPROM), a magnetic disk, a flexible disk, an optical disk, a compact disk, a mini disk, a digital versatile disc (DVD), a compact disc (CD), a USB memory, or the like.

The program stored in the storage device 300 and executed by the CPU 100 is implemented by software, firmware, or a combination of software and firmware.

The program to be executed by the CPU 100, which is stored in the storage device 300, includes the procedures of: determining whether or not the driver is capable of driving on the basis of driver state information which makes it possible to estimate whether the driver is in a state where the driver can perform a driving operation; generating measured map information for a side wall including a side wall of an evacuation spot on the basis of surrounding environment information including surrounding position information indicating a measured position of the side wall including the side wall of the evacuation spot and division line information indicating a measured division line of a traveling path; calculating a correction value obtained by multiplying a difference between a distance from a traveling center line of the host vehicle to the side wall including the side wall of the evacuation spot in base map information and a distance from the traveling center line of the host vehicle to the side wall including the side wall of the evacuation spot in the measured map information by a reliability that is equal to or less than 1 when it is determined that the driving operation by the driver cannot be performed, and generating corrected map information obtained by applying the correction value to the base map information; generating an evacuation travel route with the evacuation spot as a destination spot by using host vehicle position information indicating a position of the host vehicle and the corrected map information when it is determined that the driving operation by the driver cannot be performed; and outputting a vehicle speed command on the basis of the evacuation travel route when it is determined that the driving operation by the driver cannot be performed, the vehicle speed command being a command for performing speed control and steering control of the host vehicle that performs evacuation travel.

In addition, the evacuation travel assistance device 10 may be dedicated hardware, for example, a single circuit, a composite circuit, a programmed processor, a parallel programmed processor, an integrated circuit (application specific integrated circuit, that is, ASIC), a field-programmable gate array (FPGA), or a circuit obtained by combining these.

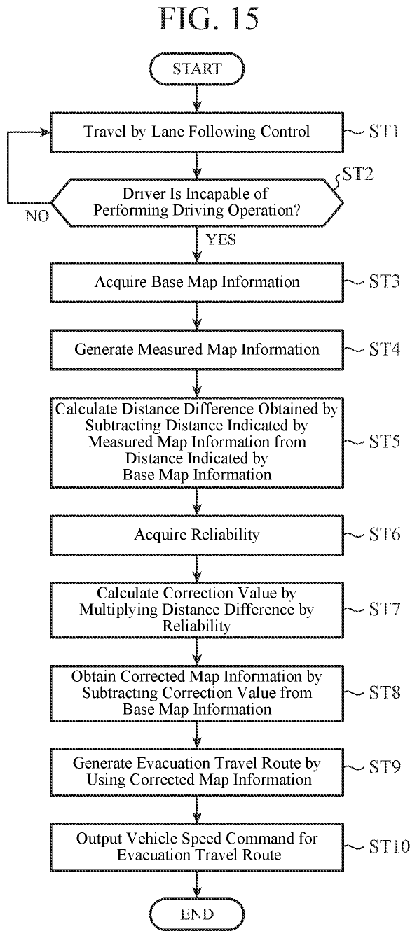

Next, an evacuation travel assistance method by the evacuation travel assistance device 10 according to the first embodiment will be described mainly on the basis of the flowchart illustrated in FIG. 15.

The evacuation travel assistance method will be mainly described in which when the host vehicle automatically travels on an automobile exclusive road by lane following control and in an emergency such as driver's incapacity to drive, the vehicle is caused to automatically travel to an evacuation spot such as a road shoulder or an emergency parking zone by route following control or the like to stop at the evacuation spot.

Step ST1 is an automatic normal traveling step in which the host vehicle automatically travels by lane following control or the like.

Step ST2 is a driving capability determining step in which the driver state determining unit 11 determines whether or not the driver can drive on the basis of the driver state information acquired from the driver state monitoring device 20.

The driver state information is information which makes it possible to estimate whether the driver is in a state where the driver can perform the driving operation.

In step ST2, when the driver state determining unit 11 determines that the driver is in a state where the driver can perform the driving operation, the process returns to step ST1 and the automatic normal traveling is continued.

On the other hand, when the driver state determining unit 11 determines that the driver is in a state where the driver cannot perform the driving operation, the process proceeds to step ST3.

Step ST3 is a base map acquiring step in which the map information acquiring unit 12 obtains base map information on the basis of map information on a road which is a traveling destination of the host vehicle acquired from the map information storage unit 30.

In step ST3, the map information acquiring unit 12 acquires the position of the side wall including the side wall of the emergency parking zone, that is, the side wall in the set area from the point A′ to the point F′ illustrated in FIG. 6 on the basis of the map information stored in the map information storage unit 30, and thereby generates base map information including distance information indicating the distance from the traveling center line of the host vehicle to the side wall including the side wall of the emergency parking zone.

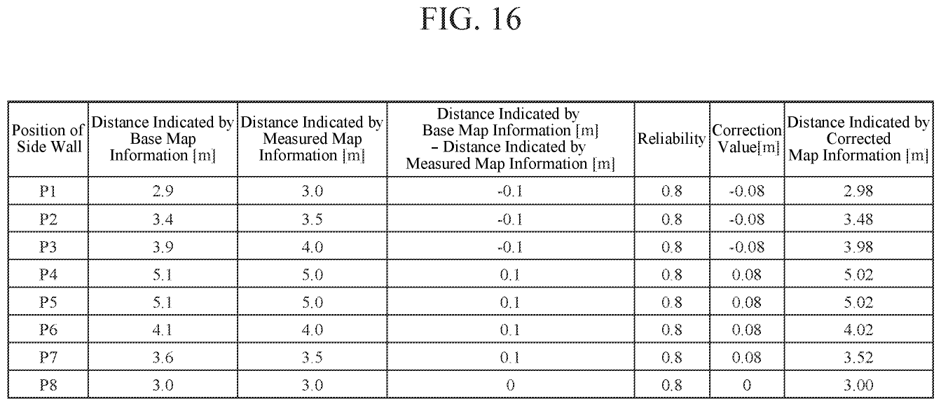

As an example, distances based on the distance information indicated by the base map information are illustrated in the second column of FIG. 16.

That is, it is assumed that the distances are obtained so that the distance D1 at the point P1 is 2.9 m, the distance D2 at the point P2 is 3.4 m, the distance D3 at the point P3 is 3.9 m, the distance D4 at the point P4 is 5.1 m, the distance D5 at the point P5 is 5.1 m, the distance D6 at the point P6 is 4.1 m, the distance D7 at the point P7 is 3.6 m, and the distance D8 at the point P8 is 3.0 m.

The first column of FIG. 16 illustrates a point P1 to a point P8 of the side wall including the side wall of the emergency parking zone, and the point P1 to the point P8 are the point P1 to the point P8 illustrated in FIG. 6.

Step ST4 is a measured map generating step in which the surrounding environment information generating unit 14 generates measured map information on the basis of the surrounding environment information from the millimeter-wave radar 50.

In step ST4, the surrounding environment information generating unit 14 generates measured map information for the side wall including the side wall of the emergency parking zone on the basis of the surrounding environment information including the surrounding position information indicating the measured position of the side wall including the side wall of the emergency parking zone and the division line information indicating the division line of the traveling path from the millimeter-wave radar 50.

In step ST4, the surrounding environment information generating unit 14 detects the position of the side wall including the side wall of the emergency parking zone, that is, the side wall in the set area from the point A to the point F illustrated in FIG. 7 on the basis of the surrounding environment information from the millimeter-wave radar 50, and thereby generates measured map information including distance information indicating the distance from the traveling center line of the host vehicle to the side wall including the side wall of the emergency parking zone.

As an example, distances based on the distance information indicated by the measured map information are illustrated in the third column of FIG. 16.

That is, it is assumed that the distances are obtained so that the distance D1-1 at the point P1 is 3.0 m, the distance D2-1 at the point P2 is 3.5 m, the distance D3-1 at the point P3 is 4.0 m, the distance D4-1 at the point P4 is 5.0 m, the distance D5-1 at the point P5 is 5.0 m, the distance D6-1 at the point P6 is 4.0 m, the distance D7-1 at the point P7 is 3.5 m, and the distance D8-1 at the point P8 is 3.0 m.

Note that, in the measured map information, the section of the set area and the positions for which distance information is calculated are the same as those of the position information of the side wall obtained from the base map information.

Step ST5 is a distance difference calculating step in which the corrected map information generating unit 15 calculates a distance difference obtained by subtracting the distance indicated by the measured map information from the distance indicated by the base map information.

An example of the values of the distance differences obtained when in step ST5 the corrected map information generating unit 15 subtracts the distances based on the distance information indicated by the measured map information generated in step ST4 from the distances based on the distance information indicated by the base map information acquired in step ST3 is illustrated in the fourth column of FIG. 16.

That is, the distance difference at the point P1 is −0.1 m, the distance difference at the point P2 is −0.1 m, the distance difference at the point P3 is −0.1 m, the distance difference at the point P4 is 0.1 m, the distance difference at the point P5 is 0.1 m, the distance difference at the point P6 is 0.1 m, the distance difference at the point P7 is 0.1 m, and the distance difference at the point P8 is 0 m.

Step ST6 is a reliability acquiring step in which the corrected map information generating unit 15 acquires the reliability that is the detection reliability when the side wall in the set area is detected by the millimeter-wave radar 50 on the basis of the surrounding environment information from the millimeter-wave radar 50.

In step ST6, the corrected map information generating unit 15 obtains the reception intensity and the reception density of the incoming wave, which correspond to one piece of the surrounding environment information from the millimeter-wave radar 50, and determines the reliability on the basis of the map illustrated in FIG. 9.

As an example, an example in which 0.8 is obtained as the reliabilities of the point P1 to the point P8 from the reception intensity and the reception density of the incoming wave by the reflected wave from the side wall in the set area from the point A to the point F is illustrated in the fifth column of FIG. 16.

In step ST6, an example in which 0.8 is obtained as the reliabilities of the point P1 to the point P8 has been described for the sake of simplicity of explanation, but the corrected map information generating unit 15 may determine the reliability for each point as a result of the reception intensity and the reception density of the incoming wave so that the reliability of the point P1 is 0.8, the reliabilities of the point P2 to the point P4 are 0.9, the reliabilities of the point P5 to the point P7 are 0.7, and the reliability of the point P8 is 0.8, for example.

Step ST7 is a correction value calculating step in which the corrected map information generating unit 15 calculates a correction value.

An example of the correction values obtained when in step ST7 the corrected map information generating unit 15 multiplies the distance differences obtained in step ST5 by subtracting the distances indicated by the measured map information from the distances indicated by the base map information by the reliabilities obtained in step ST6 is illustrated in the sixth column of FIG. 16.

That is, the correction value at the point P1 is −0.08 m, the correction value at the point P2 is −0.08 m, the correction value at the point P3 is −0.08 m, the correction value at the point P4 is 0.08 m, the correction value at the point P5 is 0.08 m, the correction value at the point P6 is 0.08 m, the correction value at the point P7 is 0.08 m, and the correction value at the point P8 is 0 m.

Step ST8 is a corrected map information generating step in which the corrected map information generating unit 15 generates corrected map information obtained by applying the correction value to the base map information.

An example of distances based on the corrected map information obtained when in step ST8 the corrected map information generating unit 15 subtracts the correction values obtained in step ST7 from the distances based on the distance information indicated by the base map information obtained in step ST3 is illustrated in the seventh column of FIG. 16.

That is, the distances are obtained so that the distance of the point P1 is 2.98 m, the distance of the point P2 is 3.48 m, the distance of the point P3 is 3.98 m, the distance of the point P4 is 5.02 m, the distance of the point P5 is 5.02 m, the distance of the point P6 is 4.02 m, the distance of the point P7 is 3.52 m, and the distance of the point P8 is 3.00 m.

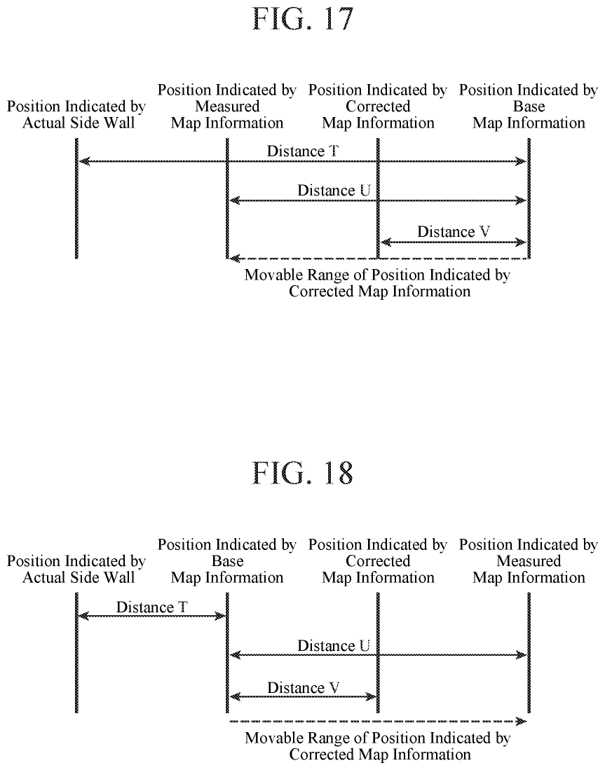

In step ST8, in the section from the point A to the point C, that is, from the point P1 to the point P3, when the position indicated by the base map information is located on the right side with respect to the position indicated by the measured map information as illustrated in FIG. 17, the position indicated by the corrected map information changes leftward from the position indicated by the base map information to the position indicated by the measured map information depending on the reliability.

In the above example, since the reliability is 0.8, the base map information is appropriately corrected with the correction value, the position indicated by the corrected map information approaches the position indicated by the measured map information, and highly reliable and highly accurate position information can be obtained with respect to the position indicated by the actual side wall.

Further, in the section from the point C to the point E, that is, from the point P4 to the point P7, when the position indicated by the base map information is located on the left side with respect to the position indicated by the measured map information as illustrated in FIG. 18, the position indicated by the corrected map information changes rightward from the position indicated by the base map information to the position indicated by the measured map information depending on the reliability.

In the above example, since the reliability is 0.8, the position indicated by the corrected map information approaches the position indicated by the measured map information, and highly reliable position information can be obtained with respect to the position indicated by the actual side wall.

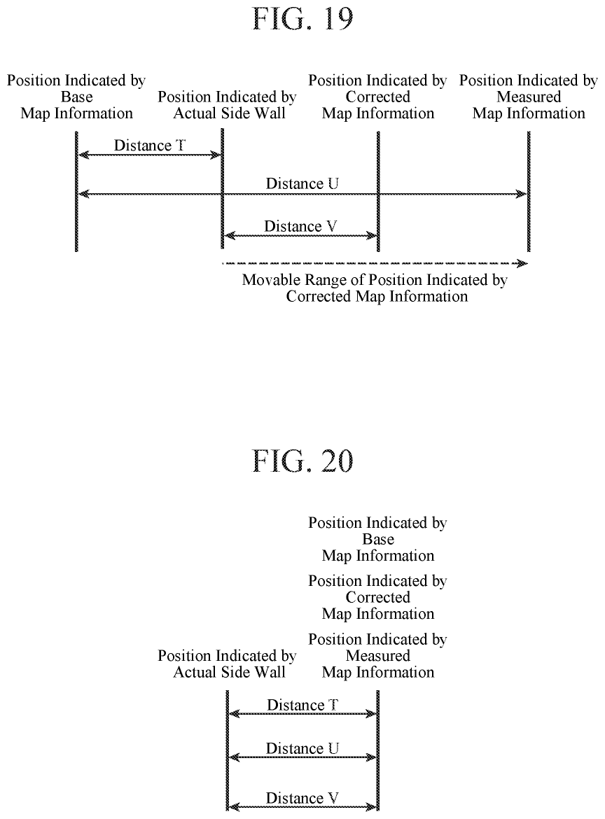

In addition, as illustrated in FIG. 19, there is a case where the position indicated by the base map information is located to the left of the position indicated by the actual side wall. Even in this case, the position indicated by the measured map information is not located to the left of the position indicated by the actual side wall, and the reliability is equal to or more than a set value that is 0.45 in the first embodiment. Therefore, the position indicated the corrected map information obtained by applying the correction value to the position indicated by the base map information is located to the right of the position indicated by the actual side wall, and highly reliable and highly accurate position information can be obtained with respect to the position indicated by the actual side wall. Therefore, it is safe to stop the vehicle in the emergency parking zone.

On the other hand, when the reliability is less than the set value, the corrected map information generating unit 15 sets the position indicated by the measured map information as the position of the corrected map information in order to ensure safety.

In order to ensure further safety, when the position indicated by the base map information is located on the left side with respect to the position indicated by the measured map information as illustrated in FIG. 18, the corrected map information generating unit 15 may set the position indicated by the measured map information as the position of the corrected map information regardless of the reliability.

In the section from the point E to the point F, that is, at the point P8, the position indicated by the base map information is the same as the position indicated by the measured map information as illustrated in FIG. 20, and the position indicated by the corrected map information is the same as the position indicated by the base map information and the position indicated by the measured map information.

Step ST9 is an evacuation travel route generating step in which the route generating unit 16 generates an evacuation travel route using the corrected map information generated by the corrected map information generating unit 15.

In step ST9, the route generating unit 16 uses the host vehicle position information indicating the position of the host vehicle acquired by the host vehicle environment recognizing unit 13 and the corrected map information generated by the corrected map information generating unit 15 to generate an evacuation travel route with the position of the host vehicle as a departure spot and a stop position in the emergency parking zone as a destination spot.

Step ST10 is a vehicle speed command outputting step in which the vehicle control unit 17 outputs a vehicle speed command for the evacuation travel route generated by the route generating unit 16.

In step ST10, the vehicle control unit 17 outputs a vehicle speed command for performing speed control and steering control of the host vehicle that performs evacuation travel on the basis of the evacuation travel route generated by the route generating unit 16 to the vehicle equipment 60.

Upon receiving the vehicle speed command from the vehicle control unit 17, the vehicle equipment 60 controls the speed and the steering angle of the host vehicle along the evacuation travel route in accordance with the target vehicle speed and the target steering angle of the vehicle speed command to control the host vehicle so as to stop at the stop point of the emergency parking zone. When performing the control to stop, the vehicle equipment 60 controls the deceleration, the steering angle, and the like appropriately depending on the speed of the host vehicle, the presence or absence of a surrounding object, and the like to control the host vehicle so as to safely stop at the stop point.

As described above, the evacuation travel assistance device 10 according to the first embodiment that causes the vehicle to automatically travel to the evacuation spot and stop at the evacuation spot when it is determined that the driving operation by the driver cannot be performed during automatic travel is configured so that the following processes are performed. The corrected map information generating unit 15 calculates a correction value obtained by multiplying a difference between a distance from a traveling center line of the host vehicle to a side wall including a side wall of the evacuation spot in the base map information obtained by the map information acquiring unit 12 and a distance from the traveling center line of the host vehicle to the side wall including the side wall of the evacuation spot in the measured map information generated by the surrounding environment information generating unit 14 by a reliability that is equal to or less than 1, and generates corrected map information obtained by applying the correction value to the base map information obtained by the map information acquiring unit 12. The route generating unit 16 generates the evacuation travel route with the evacuation spot as the destination spot using the corrected map information generated by the corrected map information generating unit 15. The vehicle control unit 17 outputs the vehicle speed command for performing evacuation travel on the basis of the evacuation travel route generated by the route generating unit 16. Thus, it is possible to increase the accuracy of the position information of the side wall of the evacuation spot and to perform control of the host vehicle in accordance with the evacuation travel route accurate with respect to the evacuation spot and the vehicle speed command along the evacuation travel route.

In addition, since the evacuation travel assistance device 10 according to the first embodiment generates base map information on the basis of map information obtained from a map information acquiring device such as a locator, the evacuation travel assistance device 10 can determine a search for an evacuation spot at an early stage on the basis of information up to a distance invisible from the host vehicle as map information.

Moreover, since the correction value is created for the evacuation spot and the side wall in the vicinity of the evacuation spot on the basis of information on the side wall in an actually visible range by using the measured map information generated from the surrounding environment information obtained from the surrounding environment information acquiring device 50 such as a millimeter-wave radar, information close to the actual side wall can be obtained for the evacuation spot and the side wall in the vicinity of the evacuation spot.

### Second Embodiment

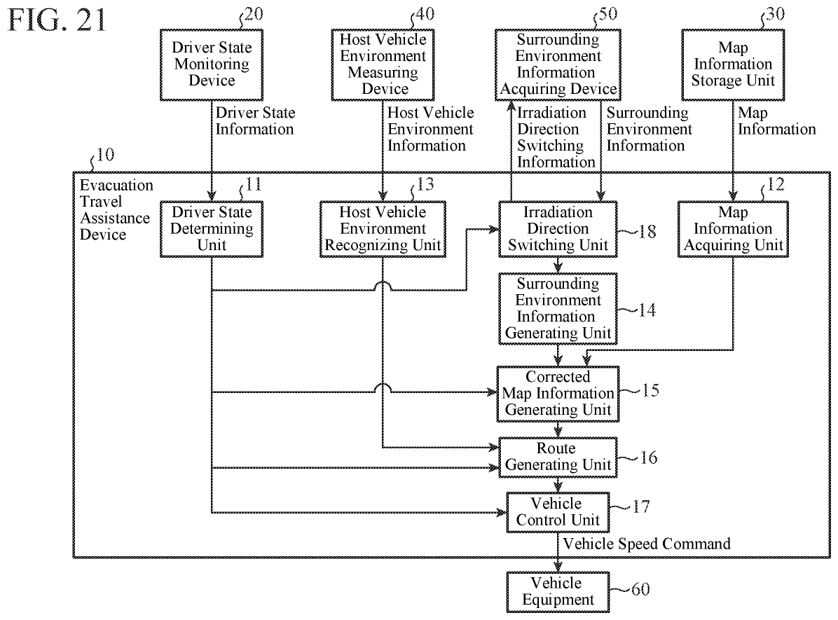

An evacuation travel assistance device 10 according to a second embodiment will be described with reference to FIGS. 21 to 24.

The evacuation travel assistance device 10 according to the second embodiment is different from the evacuation travel assistance device 10 according to the first embodiment in that an irradiation direction switching unit 18 is provided at a preceding stage of the surrounding environment information generating unit 14, and the other points are the same.

In FIGS. 21 to 24, the same reference numerals as those in FIGS. 1 to 20 denote the same or corresponding parts.

When the driver state determining unit 11 determines that the driving operation by the driver cannot be performed, the irradiation direction switching unit 18 outputs, to the millimeter-wave radar 50, irradiation direction switching information for instructing the millimeter-wave radar 50 to change or switch the irradiation direction so that the irradiation density of the transmission wave emitted from the millimeter-wave radar 50 to the position of the side wall including the side wall of the emergency parking zone is relatively higher than the irradiation density in the other area.

When the driver state determining unit 11 determines that the driving operation by the driver cannot be performed, the surrounding environment information generating unit 14 acquires surrounding environment information from the millimeter-wave radar 50 whose irradiation direction has been changed in accordance with the irradiation direction switching information from the irradiation direction switching unit 18, and generates measured map information for the side wall including the emergency parking zone on the basis of the acquired surrounding environment information.

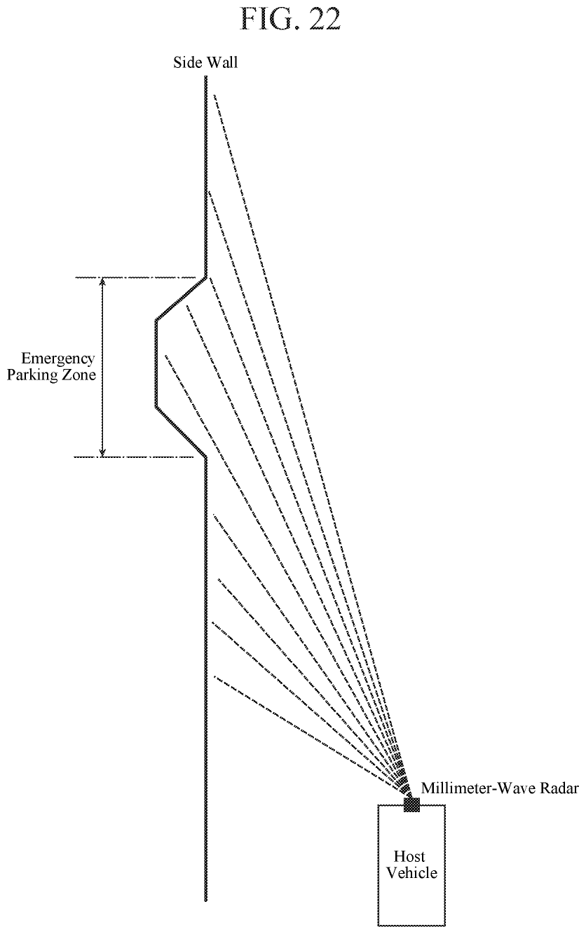

When the driver state determining unit 11 determines that the driving operation by the driver can be performed, the millimeter-wave radar 50 irradiates the side wall with the transmission wave at uniform intervals as illustrated in FIG. 22.

On the other hand, when the driver state determining unit 11 determines that the driving operation by the driver cannot be performed, the irradiation direction switching unit 18 provides irradiation direction switching information to the millimeter-wave radar 50.

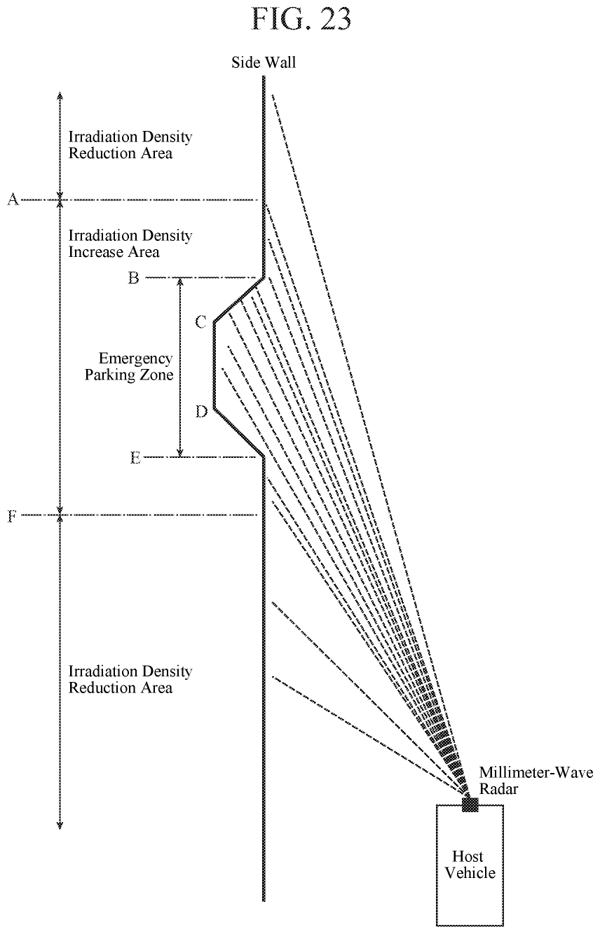

Upon receiving the irradiation direction switching information, the millimeter-wave radar 50 changes the emission direction of the transmission wave, that is, the irradiation direction of the transmission wave in accordance with the irradiation direction switching information in such a way as to increase the irradiation density for the side wall including the emergency parking zone (point B to point E) from the point A to the point F as illustrated in FIG. 23.

The side wall including the emergency parking zone from the point A to the point F is an irradiation density increase area, and the side wall other than the point A to the point F is an irradiation density reduction area.

The point A to the point B and the point E to the point F are the vicinity of the emergency parking zone for obtaining information necessary for the vehicle to park in the emergency parking zone. For example, the distance from the point A to the point B and the distance from the point E to the point F are each 5 m.

The distance from the point A to the point B and the distance from the point E to the point F are not limited to 5 m, and may be, for example, a half distance or ⅓ distance of the section of the emergency parking zone.

The irradiation density of the transmission wave from the millimeter-wave radar 50 to the irradiation density increase area is higher than the irradiation density of the transmission wave from the millimeter-wave radar 50 in normal automatic traveling.

That is, for the irradiation density increase area, the millimeter-wave radar 50 makes the irradiation interval narrower than the irradiation interval of the transmission wave from the millimeter-wave radar 50 in normal automatic traveling.

In this way, by increasing the irradiation density of the transmission wave from the millimeter-wave radar 50 to the irradiation density increase area, the reception intensity and the reception density of the incoming wave by the millimeter-wave radar 50 are increased, and accordingly, the detection accuracy of the position of the side wall including the emergency parking zone is improved.

In other words, by increasing the irradiation density of the transmission wave from the millimeter-wave radar 50 to the irradiation density increase area, the reception intensity and the reception density of the incoming wave received by the millimeter-wave radar 50 are increased, and thereby the accuracy of the position indicated by the measured map information generated by the surrounding environment information generating unit 14 is high and the degree of reliability used by the corrected map information generating unit 15 is a value close to 1.0. Thus, information closer to the position of the side wall including the side wall of the actual emergency parking zone can be obtained as the position information indicated by the corrected map information obtained by the corrected map information generating unit 15.

The irradiation density of the transmission wave from the millimeter-wave radar 50 to the irradiation density reduction area is set to be equal to or lower than the irradiation density of the transmission wave from the millimeter-wave radar 50 in normal automatic traveling.

That is, for the irradiation density reduction area, the millimeter-wave radar 50 sets the irradiation interval to be equal to or wider than the irradiation interval of the transmission wave from the millimeter-wave radar 50 in normal automatic traveling.

When the irradiation density of the transmission wave from the millimeter-wave radar 50 to the irradiation density reduction area is set to be lower than the irradiation density of the transmission wave from the millimeter-wave radar 50 in normal automatic traveling, the total amount of irradiation by the transmission wave from the millimeter-wave radar 50 can be made constant. Thus, even if the irradiation density of the transmission wave from the millimeter-wave radar 50 to the irradiation density increase area is increased, the energy required for irradiation in the millimeter-wave radar 50 can be reduced.

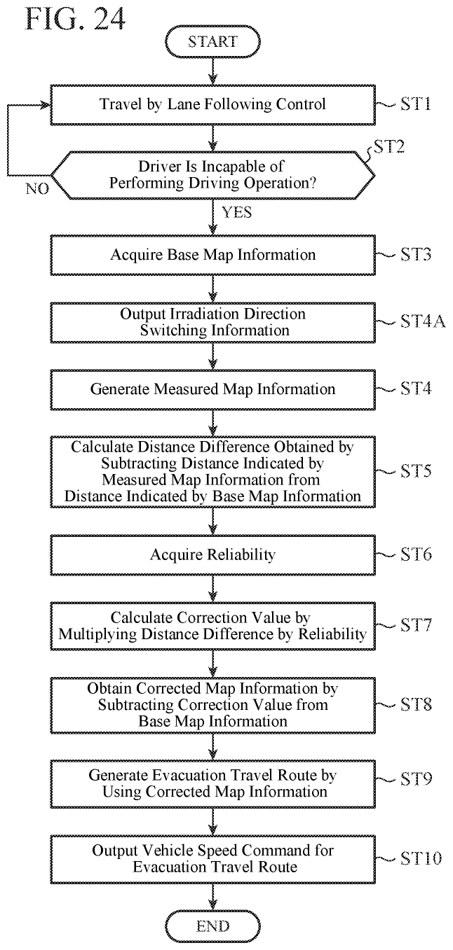

Next, an evacuation travel assistance method by the evacuation travel assistance device 10 according to the second embodiment will be described mainly on the basis of the flowchart illustrated in FIG. 24.

The evacuation travel assistance method will be mainly described in which when the host vehicle automatically travels on an automobile exclusive road by lane following control and in an emergency such as driver's incapacity to drive, the vehicle is caused to automatically travel to an evacuation spot such as a road shoulder or an emergency parking zone by route following control or the like to stop at the evacuation spot.

The automatic normal traveling step of step ST1, the driving capability determining step of step ST2, and the base map acquiring step of step ST3 are the same as the steps of steps ST1 to ST3 in the evacuation travel assistance device 10 according to the first embodiment.

Step ST4A is an irradiation direction switching step of changing or switching the irradiation direction by the transmission wave from the millimeter-wave radar 50.

In step ST4A, when the driver state determining unit 11 determines that the driving operation by the driver cannot be performed, the irradiation direction switching unit 18 provides irradiation direction switching information, which means making the irradiation interval of the transmission wave from the millimeter-wave radar 50 at the present time wide, to the millimeter-wave radar 50 when the host vehicle is traveling in the irradiation density reduction area.

The millimeter-wave radar 50 widens the irradiation interval of the transmission wave, detects and measures the situation of the surrounding environment, and outputs the surrounding environment information to the surrounding environment information generating unit 14.

When the host vehicle starts evacuation travel by autonomous driving with a stop position in the emergency parking zone as a destination spot, and the host vehicle reaches a start point of the irradiation density increase area, the irradiation direction switching unit 18 provides irradiation direction switching information to the millimeter-wave radar 50, which means making the irradiation interval of the transmission wave from the millimeter-wave radar 50 narrower than the irradiation interval of the transmission wave from the millimeter-wave radar 50 in normal automatic traveling.

The millimeter-wave radar 50 narrows the irradiation interval of the transmission wave, detects and measures the situation of the surrounding environment, and outputs the surrounding environment information to the surrounding environment information generating unit 14.

In step ST4 and subsequent steps, the measured map generating step of step ST4, the distance difference calculating step of step ST5, the reliability acquiring step of step ST6, the correction value calculating step of step ST7, the corrected map information generating step of step ST8, the evacuation travel route generating step of step ST9, and the vehicle speed command outputting step of step ST10 are the same as steps ST4 to ST10 in the evacuation travel assistance device 10 according to the first embodiment.

The vehicle equipment 60 to which the vehicle speed command for the host vehicle that performs the evacuation travel is given from the vehicle control unit 17 through the processing of steps ST1 to ST10 controls the speed and the steering angle of the host vehicle along the evacuation travel route in accordance with the target vehicle speed and the target steering angle of the vehicle speed command to control the host vehicle so as to stop at the stop point of the emergency parking zone. When performing the control to stop, the vehicle equipment 60 appropriately controls the deceleration and the steering angle depending on the speed of the host vehicle, the presence or absence of a surrounding object, and the like to control the host vehicle so as to safely stop at the stop point.

As described above, the evacuation travel assistance device 10 according to the second embodiment has an effect similar to that of the evacuation travel assistance device 10 according to the first embodiment. In addition, the irradiation direction switching unit 18 gives, to the millimeter-wave radar 50, the irradiation direction switching information for switching the emission direction of the transmission wave in such a way as to increase the irradiation density for the side wall including the emergency parking zone. Therefore, the accuracy of the position information of the side wall of the emergency parking zone can be improved, and the accuracy of detecting the position of the side wall including the emergency parking zone is further improved.

As a result, the vehicle control in which the route is generated to the accurate evacuation position of the emergency parking zone can be performed on the host vehicle.

### Third Embodiment

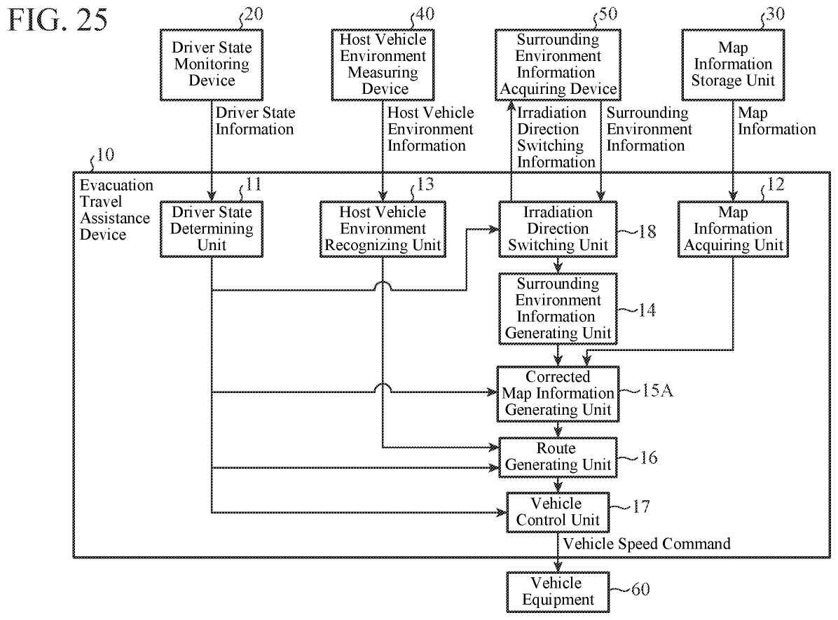

An evacuation travel assistance device 10 according to a third embodiment will be described with reference to FIGS. 25 to 30.

The evacuation travel assistance device 10 according to the third embodiment is different from the evacuation travel assistance device 10 according to the second embodiment in that a corrected map information generating unit 15A is provided instead of the corrected map information generating unit 15, and the other points are the same.

In FIGS. 25 to 30, the same reference numerals as those in FIGS. 1 to 24 denote the same or corresponding parts.

That is, in the corrected map information generating unit 15 in the evacuation travel assistance device 10 according to the second embodiment, similarly to the corrected map information generating unit 15 in the evacuation travel assistance device 10 according to the first embodiment, the reliability used by the corrected map information generating unit 15 has values of a plurality of steps from 0.1 to 1.0, and is a value selected from the values of the plurality of steps on the basis of the magnitude of the reception intensity and the reception density of the incoming wave received by the millimeter-wave radar 50 in the surrounding environment information acquired by the surrounding environment information generating unit 14.

On the other hand, reliability used by the corrected map information generating unit 15A in the evacuation travel assistance device 10 according to the third embodiment has, for the side wall including the side wall of the emergency parking zone, a value obtained by multiplying a first reliability that is equal to or less than 1 selected on the basis of the magnitude of the reception intensity and the reception density of the incoming wave received by the millimeter-wave radar 50 in the surrounding environment information acquired by the surrounding environment information generating unit 14 by a second reliability that is equal to or less than 1 corresponding to an irradiation degree of the transmission wave from the millimeter-wave radar 50 to the side wall including the side wall of the emergency parking zone.

Further, the reliability used by the corrected map information generating unit 15A is, for the side wall other than the side wall including the side wall of the emergency parking zone, the first reliability that is equal to or less than 1 selected on the basis of the magnitude of the reception intensity and the reception density of the incoming wave received by the millimeter-wave radar 50 in the surrounding environment information acquired by the surrounding environment information generating unit 14.

The corrected map information generating unit 15A calculates a correction value obtained by multiplying the difference between the distance from the traveling center line of the host vehicle to the side wall including the side wall of the emergency parking zone in the base map information obtained by the map information acquiring unit 12 and the distance from the traveling center line of the host vehicle to the side wall including the side wall of the emergency parking zone in the measured map information generated by the surrounding environment information generating unit by the reliability that is equal to or less than 1 obtained by multiplying the first reliability and the second reliability. The corrected map information generating unit 15A generates corrected map information obtained by applying the correction value to the base map information obtained by the map information acquiring unit 12.

Similarly to the reliability used by the corrected map information generating unit 15 in the evacuation travel assistance device 10 according to the first embodiment or the second embodiment, one of the reliabilities illustrated in FIG. 9 is selected as the first reliability in accordance with the reception intensity and the reception density of the incoming wave from the millimeter-wave radar 50 acquired by the surrounding environment information generating unit 14. That is, the first reliability has values of a plurality of steps from 0.1 to 1.0, and is a value selected from the values of the plurality of steps on the basis of the magnitude of the reception intensity and the reception density of the incoming wave received by the millimeter-wave radar 50.

The side wall including the side wall of the emergency parking zone, that is, the side wall from the point A to the point F illustrated in FIGS. 7 and 8 is divided into the side wall close to the cruising lane and parallel to the cruising lane, that is, the side wall from the point A to the point B and the side wall from the point E to the point F, the side wall inside the emergency parking zone far from the cruising lane and parallel to the cruising lane, that is, the side wall from the point C to the point D, the front-side oblique side wall inside the emergency parking zone and not parallel to the cruising lane, that is, the side wall from the point B to the point C, and the rear-side oblique side wall inside the emergency parking zone and not parallel to the cruising lane, that is, the side wall from the point D to the point E. For each of the side walls, the second reliability is set to a value equal to or less than 1 corresponding to the irradiation degree of the millimeter-wave radar 50 from the host vehicle to the side wall.

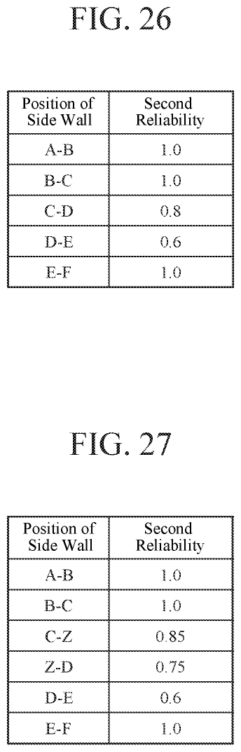

For example, as illustrated in FIG. 26 as a first example, the second reliability is set to 1 for the side wall from the point A to the point B, the side wall from the point E to the point F, and the side wall from the point B to the point C, which are easy to irradiate with the transmission wave from the millimeter-wave radar 50, set to 0.8 for the side wall from the point C to the point D, which is difficult to irradiate with the transmission wave from the millimeter-wave radar 50, and set to 0.6 for the side wall from the point D to the point E, which is most difficult to irradiate directly with the transmission wave from the millimeter-wave radar 50.

In addition, since the side wall from the point C to the point D is easy to irradiate with the transmission wave from the millimeter-wave radar 50 on the rear side rather than the front side, for example, as illustrated in FIG. 27 as a second example, the second reliability is set to 0.85 for the side wall from the point C to the intermediate point Z between the point C and the point D, and set to 0.75 for the side wall from the intermediate point Z to the point D.

Note that, in the second example, the second reliability for other than the side wall from the point C to the point D is the same as the second reliability for other than the side wall from the point C to the point D in the first example.

Since the corrected map information generating unit 15A uses the value obtained by multiplying the first reliability and the second reliability as the reliability for the side wall including the side wall of the emergency parking zone, the corrected map information in which the accuracy of the position information of the side wall of the emergency parking zone is improved can be obtained.

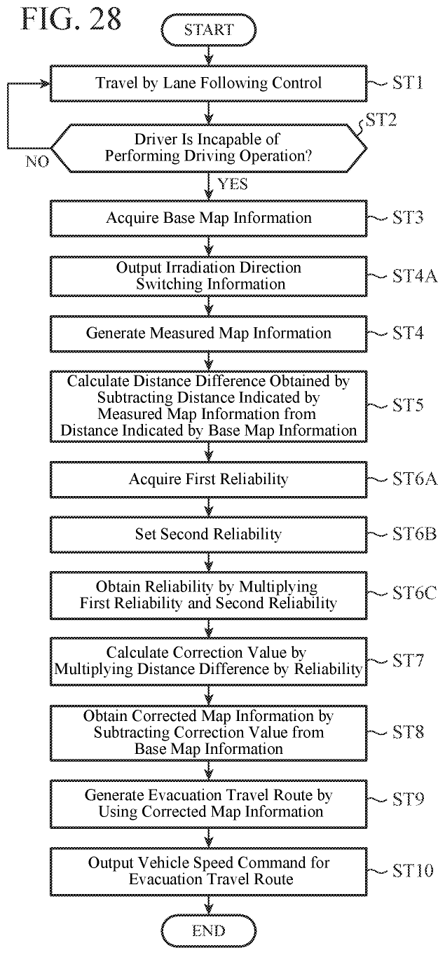

Next, an evacuation travel assistance method by the evacuation travel assistance device 10 according to the third embodiment will be described mainly on the basis of the flowchart illustrated in FIG. 28.

The reliability acquiring step in the evacuation travel assistance device 10 according to the third embodiment is different from the reliability acquiring step ST6 in the evacuation travel assistance device 10 according to the second embodiment in that the reliability acquiring step includes a step ST6A of acquiring the first reliability, a step ST6B of setting the second reliability, and a reliability calculating step ST6C of obtaining the reliability, and the other steps are the same.

That is, the automatic normal traveling step in step ST1, the driving capability determining step in step ST2, the base map acquiring step in step ST3, the irradiation direction switching step in step ST4A, the measured map generating step in step ST4, the distance difference calculating step in step ST5, the correction value calculating step in step ST7, the corrected map information generating step in step ST8, the evacuation travel route generating step in step ST9, and the vehicle speed command outputting step in step ST10 are the same as the steps in steps ST1 to ST5 and step ST7 in the evacuation travel assistance device 10 according to the second embodiment.

Therefore, step ST6A of acquiring the first reliability, step ST6B of setting the second reliability, and step ST6C of obtaining the reliability will be mainly described.

Step ST6A of acquiring the first reliability corresponds to step ST6 in the evacuation travel assistance device 10 according to the first embodiment or the second embodiment. In step ST6A, the corrected map information generating unit 15A obtains the reception intensity and the reception density of the incoming wave, which correspond to one piece of the surrounding environment information from the millimeter-wave radar 50, and determines the first reliability on the basis of the map illustrated in FIG. 9.

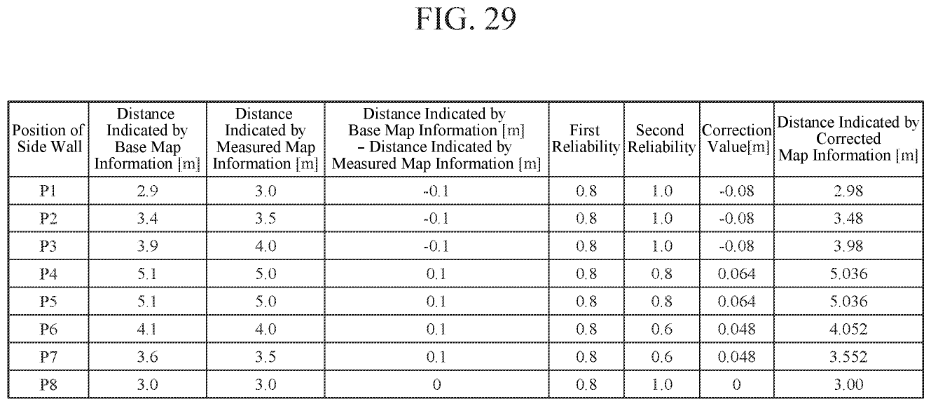

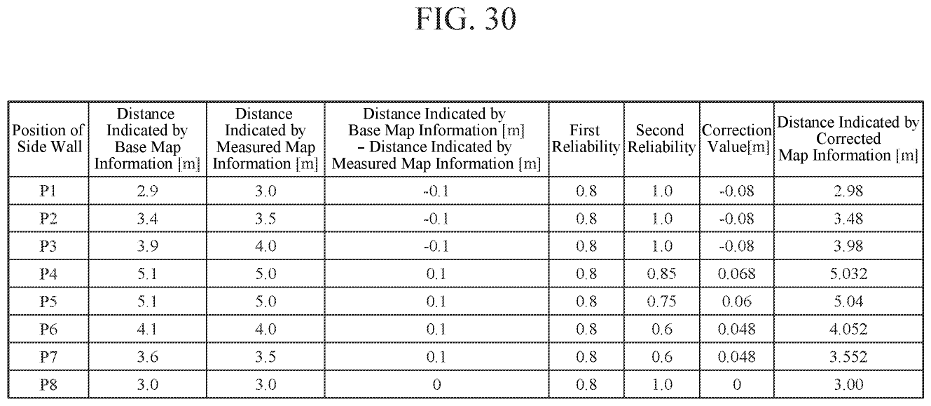

As an example, an example in which 0.8 is obtained as the reliability for the point P1 to the point P8 illustrated in the first embodiment is illustrated in the fifth column of each of FIGS. 29 and 30.

In both FIG. 29 and FIG. 30, the same examples as up to the fifth column shown in the first embodiment are used.

In step ST6B of setting the second reliability, the corrected map information generating unit 15A sets, for the side wall including the side wall of the emergency parking zone, the second reliabilities of the side wall from the point A to the point B, the side wall from the point B to the point C, the side wall from the point C to the point D or the side wall from the point C to the intermediate point Z and the side wall from the intermediate point Z to the point D, the side wall from the point D to the point E, and the side wall from the point E to the point F using, for example, the first example illustrated in FIG. 26 or the second example illustrated in FIG. 27 stored in a storage unit. Thereby, the corrected map information generating unit 15A determines the second reliabilities of the point P1 to the point P8.

The second reliabilities of the point P1 to the point P8 in the case of using the first example illustrated in FIG. 26 as the setting of the second reliability are illustrated in the sixth column of FIG. 29.

That is, since the point P1 is located in the section from the point A to the point B, the corrected map information generating unit 15A determines the second reliability of the point P1 to be 1.0, since the point P2 and the point P3 are located in the section from the point B to the point C, it determines the second reliability of each of the point P2 and the point P3 to be 1.0, since the point P4 and the point P5 are located in the section from the point C to the point D, it determines the second reliability of each of the point P4 and the point P5 to be 0.8, since the point P6 and the point P7 are located in the section from the point D to the point E, it determines the second reliability of each of the point P6 and the point P7 to be 0.6, and since the point P8 is located in the section from the point E to the point F, it determines the second reliability of the point P8 to be 1.0.

The second reliabilities of the point P1 to the point P8 in the case of using the second example illustrated in FIG. 27 as the setting of the second reliability are illustrated in the sixth column of FIG. 30.

Since the second example is different from the first example only in that the section from the point C to the point D is divided into two sections of a section from the point C to the intermediate point Z and a section from the intermediate point Z to the point D, the second reliabilities of the point P4 and the point P5 are only different from those of the first example.

Since the point P4 is located in the section from the point C to the intermediate point Z, the corrected map information generating unit 15A determines the second reliability of the point P4 to be 0.85, and since the point P5 is located in the section from the intermediate point Z to the point D, it determines the second reliability of the point P5 to be 0.75.

In step ST6C of obtaining the reliability, the corrected map information generating unit 15A multiplies, for each of the point P1 to the point P8, the first reliability and the second reliability to calculate the reliability.

An example of the correction values obtained in step ST7 by the corrected map information generating unit 15A multiplying the reliabilities obtained in step ST6C by the distance differences obtained in step ST5 by subtracting the distances indicated by the measured map information from the distances indicated by the base map information is illustrated in the seventh column of each of FIGS. 29 and 30.

That is, in a first example illustrated in FIG. 29, the correction value at point P1 is −0.08 m, the correction value at point P2 is −0.08 m, the correction value at point P3 is −0.08 m, the correction value at point P4 is 0.064 m, the correction value at point P5 is 0.064 m, the correction value at point P6 is 0.048 m, the correction value at point P7 is 0.048 m, and the correction value at point P8 is 0 m.

In a second example illustrated in FIG. 30, the correction value at point P1 is −0.08 m, the correction value at point P2 is −0.08 m, the correction value at point P3 is −0.08 m, the correction value at point P4 is 0.068 m, the correction value at point P5 is 0.06 m, the correction value at point P6 is 0.048 m, the correction value at point P7 is 0.048 m, and the correction value at point P8 is 0 m.

An example of distances based on the corrected map information obtained in step ST8 by the corrected map information generating unit 15A subtracting the correction values obtained in step ST7 from the distances based on the distance information indicated by the base map information obtained in step ST3 is illustrated in the eighth column of each of FIGS. 29 and 30.

That is, in the first example illustrated in FIG. 29, the distances are obtained so that the distance of point P1 is 2.98 m, the distance of point P2 is 3.48 m, the distance of point P3 is 3.98 m, the distance of point P4 is 5.036 m, the distance of point P5 is 5.036 m, the distance of point P6 is 4.052 m, the distance of point P7 is 3.552 m, and the distance of point P8 is 3.00 m.

In addition, in the second example illustrated in FIG. 30, the distances are obtained so that the distance of point P1 is 2.98 m, the distance of point P2 is 3.48 m, the distance of point P3 is 3.98 m, the distance of point P4 is 5.032 m, the distance of point P5 is 5.04 m, the distance of point P6 is 4.052 m, the distance of point P7 is 3.552 m, and the distance of point P8 is 3.00 m.

As described above, as to the side wall including the side wall of the emergency parking zone, when the position of the side wall indicated by the measured map information is located to the right of the position of the side wall indicated by the base map information, information closer to the position of the actual side wall can be obtained as the position indicated by the corrected map information, by applying the second reliability that is less than 1 to the position which is difficult to irradiate with the transmission wave from the millimeter-wave radar 50 and thus may lower the reception intensity and the reception density of the incoming wave.

Also in this case, the position indicated by the measured map information is not located to the left of the position indicated by the actual side wall, and the reliability is equal to or more than a set value that is 0.45 in the third embodiment. Therefore, the position indicated by the corrected map information obtained by applying the correction value to the position indicated by the base map information is located to the right of the position indicated by the actual side wall, and highly reliable and highly accurate position information can be obtained with respect to the position indicated by the actual side wall. Therefore, it is safe to stop the vehicle in the emergency parking zone.

In step ST9, the route generating unit 16 uses the host vehicle position information indicating the position of the host vehicle acquired by the host vehicle environment recognizing unit 13 and the corrected map information generated by the corrected map information generating unit 15A to generate an evacuation travel route with the position of the host vehicle as a departure spot and a stop position in the emergency parking zone as a destination spot.

In step ST10, the vehicle control unit 17 outputs a vehicle speed command for performing speed control and steering control of the host vehicle that performs evacuation travel on the basis of the evacuation travel route generated by the route generating unit 16 to the vehicle equipment 60.

The vehicle equipment 60 to which the vehicle speed command for the host vehicle that performs the evacuation travel is given from the vehicle control unit 17 through the processing of steps ST1 to ST10 controls the speed and the steering angle of the host vehicle along the evacuation travel route in accordance with the target vehicle speed and the target steering angle of the vehicle speed command to control the host vehicle so as to stop at the stop point of the emergency parking zone. When performing the control to stop, the vehicle equipment 60 appropriately controls the deceleration and the steering angle depending on the speed of the host vehicle, the presence or absence of a surrounding object, and the like to control the host vehicle so as to safely stop at the stop point.

As described above, the evacuation travel assistance device 10 according to the third embodiment has an effect similar to that of the evacuation travel assistance device 10 according to the second embodiment. In addition, for the side wall including the side wall of the emergency parking zone, the evacuation travel assistance device 10 according to the third embodiment uses the second reliability that is equal to or less than 1 corresponding to the irradiation degree of the transmission wave from the millimeter-wave radar 50, and sets the value obtained by multiplying the first reliability and the second reliability as the reliability. Therefore, the accuracy of the position information of the side wall of the emergency parking zone can be improved, and the accuracy of detecting the position of the side wall including the emergency parking zone is further improved.

As a result, the vehicle control in which the route is generated to the accurate evacuation position of the emergency parking zone can be performed on the host vehicle.

Note that, although in the evacuation travel assistance device 10 according to the third embodiment, the corrected map information generating unit 15A is applied to the corrected map information generating unit 15 in the evacuation travel assistance device 10 according to the second embodiment, the corrected map information generating unit 15A may be applied to the corrected map information generating unit 15 in the evacuation travel assistance device 10 according to the first embodiment.

Note that it is possible to freely combine the embodiments, to modify any components of the embodiments, or to omit any components of the embodiments.

### INDUSTRIAL APPLICABILITY

The evacuation travel assistance device 10 according to the present disclosure is preferably applied to a vehicle control system that causes a vehicle such as an automobile to automatically travel by lane following control or the like.

### REFERENCE SIGNS LIST

10: evacuation travel assistance device, 11: driver state determining unit, 12: map information acquiring unit, 13: host vehicle environment recognizing unit, 14: surrounding environment information generating unit, 15, 15A: corrected map information generating unit, 16: route generating unit, 17: vehicle control unit, 18: irradiation direction switching unit, 20: driver state monitoring device, 30: map information storage unit, 40: host vehicle environment measuring device, 50: surrounding environment information acquiring device

1. An evacuation travel assistance device comprising:
processing circuitry
to acquire driver state information and determine whether a driver is capable of driving on a basis of the driver state information, the driver state information making it possible to estimate whether the driver is in a state where the driver can perform a driving operation;
to acquire host vehicle environment information including host vehicle position information indicating a position of a host vehicle;
to acquire map information on a road that is a traveling destination of the host vehicle and obtain, on a basis of the map information, base map information;
to acquire surrounding environment information including surrounding position information and division line information and generate measured map information for a side wall including a side wall of an evacuation spot on a basis of the surrounding position information, the surrounding position information indicating a position of the side wall including the side wall of the evacuation spot measured by a surrounding environment information acquiring device, the division line information indicating a division line of a traveling path measured by the surrounding environment information acquiring device;
to calculate, when it is determined that the driving operation by the driver cannot be performed, a correction value obtained by multiplying a difference between a distance from a traveling center line of the host vehicle to the side wall including the side wall of the evacuation spot in the base map information and a distance from the traveling center line of the host vehicle to the side wall including the side wall of the evacuation spot in the measured map information by a reliability that is equal to or less than 1, and generate corrected map information obtained by applying the correction value to the base map information;
to generate, when it is determined that the driving operation by the driver cannot be performed, an evacuation travel route with the evacuation spot as a destination spot by using the host vehicle position information and the corrected map information; and
to output, when it is determined that the driving operation by the driver cannot be performed, a vehicle speed command on a basis of the evacuation travel route, the vehicle speed command being a command for performing speed control and steering control of the host vehicle that performs evacuation travel.

2. The evacuation travel assistance device according to claim 1, wherein
when the distance from the traveling center line of the host vehicle to the side wall including the side wall of the evacuation spot in the base map information is larger than the distance from the traveling center line of the host vehicle to the side wall including the side wall of the evacuation spot in the measured map information and the reliability is equal to or more than a set value, the processing circuitry generates the corrected map information to which the correction value is applied, and
when the reliability is less than the set value, the processing circuitry generates corrected map information to which the distance from the traveling center line of the host vehicle to the side wall including the side wall of the evacuation spot in the measured map information is applied.

3. The evacuation travel assistance device according to claim 1, wherein when the distance from the traveling center line of the host vehicle to the side wall including the side wall of the evacuation spot in the base map information is larger than the distance from the traveling center line of the host vehicle to the side wall including the side wall of the evacuation spot in the measured map information, the processing circuitry generates, regardless of the reliability, corrected map information to which the distance from the traveling center line of the host vehicle to the side wall including the side wall of the evacuation spot in the measured map information is applied.

4. The evacuation travel assistance device according to claim 1, wherein the surrounding environment information acquiring device is a millimeter-wave radar.

5. The evacuation travel assistance device according to claim 4, wherein the processing circuitry gives, when it is determined that the driving operation by the driver cannot be performed, irradiation direction switching information to the millimeter-wave radar, the irradiation direction switching information giving an instruction to change an irradiation direction so that an irradiation density of the millimeter-wave radar on the side wall including the side wall of the evacuation spot is relatively higher than an irradiation density of the millimeter-wave radar on another area.

6. The evacuation travel assistance device according to claim 5, wherein the irradiation direction switching information is information which means making an irradiation interval of a transmission wave from the millimeter-wave radar for the side wall including the side wall of the evacuation spot narrower than an irradiation interval of the transmission wave from the millimeter-wave radar in normal automatic traveling.

7. The evacuation travel assistance device according to claim 5, wherein the irradiation direction switching information is information which means making an irradiation interval of a transmission wave from the millimeter-wave radar for the side wall including the side wall of the evacuation spot narrower than an irradiation interval of the transmission wave from the millimeter-wave radar in normal automatic traveling, and which means making an irradiation interval of the transmission wave from the millimeter-wave radar for a side wall other than the side wall including the side wall of the evacuation spot wider than the irradiation interval of the transmission wave from the millimeter-wave radar in the normal automatic traveling.

8. The evacuation travel assistance device according to claim 4, wherein the reliability is a value selected on a basis of magnitudes of a reception intensity and a reception density of an incoming wave received by the millimeter-wave radar, the reception intensity and the reception density being included in the surrounding environment information.

9. The evacuation travel assistance device according to claim 4, wherein the reliability is one of values of a plurality of steps from 0.1 to 1.0, and is a value selected from the values of the plurality of steps on a basis of magnitudes of a reception intensity and a reception density of an incoming wave received by the millimeter-wave radar, the reception intensity and the reception density being included in the surrounding environment information.

10. The evacuation travel assistance device according to claim 4, wherein the reliability is set, for the side wall including the side wall of the evacuation spot, to a value obtained by multiplying a first reliability that is equal to or less than 1 selected on a basis of magnitudes of a reception intensity and a reception density of an incoming wave received by the millimeter-wave radar by a second reliability that is equal to or less than 1 corresponding to an irradiation degree of a transmission wave from the millimeter-wave radar to the side wall including the side wall of the evacuation spot, the reception intensity and the reception density being included in the surrounding environment information.

11. The evacuation travel assistance device according to claim 4, wherein the reliability is set, for the side wall including the side wall of the evacuation spot, to a value obtained by multiplying a first reliability that is one of values of a plurality of steps from 0.1 to 1.0, and that is a value selected from the values of the plurality of steps on a basis of magnitudes of a reception intensity and a reception density of an incoming wave received by the millimeter-wave radar by a second reliability that is equal to or less than 1 corresponding to an irradiation degree of a transmission wave from the millimeter-wave radar to the side wall including the side wall of the evacuation spot, the reception intensity and the reception density being included in the surrounding environment information.

12. An evacuation travel assistance method comprising:
determining whether a driver is capable of driving on a basis of driver state information which makes it possible to estimate whether the driver is in a state where the driver can perform a driving operation;
generating measured map information for a side wall including a side wall of an evacuation spot on a basis of surrounding environment information including surrounding position information indicating a measured position of the side wall including the side wall of the evacuation spot and division line information indicating a measured division line of a traveling path;
calculating a correction value obtained by multiplying a difference between a distance from a traveling center line of a host vehicle to the side wall including the side wall of the evacuation spot in base map information and a distance from the traveling center line of the host vehicle to the side wall including the side wall of the evacuation spot in the measured map information by a reliability that is equal to or less than 1 when it is determined that the driving operation by the driver cannot be performed, and generating corrected map information obtained by applying the correction value to the base map information;
generating an evacuation travel route with the evacuation spot as a destination spot by using host vehicle position information indicating a position of the host vehicle and the corrected map information when it is determined that the driving operation by the driver cannot be performed; and
outputting a vehicle speed command on a basis of the evacuation travel route when it is determined that the driving operation by the driver cannot be performed, the vehicle speed command being a command for performing speed control and steering control of the host vehicle that performs evacuation travel.

13. A non-transitory computer readable recording medium having stored thereon a program to be executed on a computer, the program causing the computer to perform:
determining whether a driver is capable of driving on a basis of driver state information which makes it possible to estimate whether the driver is in a state where the driver can perform a driving operation;
generating measured map information for a side wall including a side wall of an evacuation spot on a basis of surrounding environment information including surrounding position information indicating a measured position of the side wall including the side wall of the evacuation spot and division line information indicating a measured division line of a traveling path;
calculating a correction value obtained by multiplying a difference between a distance from a traveling center line of a host vehicle to the side wall including the side wall of the evacuation spot in base map information and a distance from the traveling center line of the host vehicle to the side wall including the side wall of the evacuation spot in the measured map information by a reliability that is equal to or less than 1 when it is determined that the driving operation by the driver cannot be performed, and generating corrected map information obtained by applying the correction value to the base map information;
generating an evacuation travel route with the evacuation spot as a destination spot by using host vehicle position information indicating a position of the host vehicle and the corrected map information when it is determined that the driving operation by the driver cannot be performed; and
outputting a vehicle speed command on a basis of the evacuation travel route when it is determined that the driving operation by the driver cannot be performed, the vehicle speed command being a command for performing speed control and steering control of the host vehicle that performs evacuation travel.
